(19) United States
(12) Patent Application Publication
(10) Pub. No.: US 2006/0276335 A1
(43) Pub. Date: Dec. 7, 2006

(54) Reversible multicolor recording medium and recording method using same

(75) Inventors: Hisanori Tsuboi, Kanagawa (JP); Kenichi Kurihara, Tokyo (JP); Noriyuki Kishii, Tokyo (JP)

Correspondence Address: BELL, BOYD & LLOYD, LLC, P. O. BOX 1135, CHICAGO, IL, 60690-1135, US

(73) Assignee: SONY CORPORATION, Tokyo (JP)

(21) Appl. No.: 10/565,918

(22) PCT Filed: Aug. 16, 2004
(86) PCT No.: PCT/JP04/12035

§ 371 Date: Jan. 25, 2006

(30) Foreign Application Priority Data
Aug. 21, 2003 (JP) 2003-297407

(51) Int. Cl. B05D 5/12; B05D 3/00; B41M 5/24

(52) U.S. Cl. 503/201; 427/532; 427/127

(57) ABSTRACT

A reversible multicolor thermal recording medium capable of recording and erasing repeatedly high-contrast clear images free of color fogging without causing color deterioration and a method for recording on the recording medium.

The reversible multicolor recording medium includes recording layers numbered from the first to the nth, which are formed on a supporting substrate separately and independently in sequential order, the recording layers each containing a reversible thermal color developing composition differing from one another in the hue of the developed color and further containing a light-heat converting composition which generates heat upon absorption of near infrared rays with a wavelength in different ranges, and the recording layers having respectively the absorption peak wavelengths λ max 1, λ max 2, . . . , λ max n, in the near infrared region such that 1500 nm>λ max 1>λ max 2> . . . >λ max n>750 nm.

### TECHNICAL FIELD

The present invention relates to a reversible multicolor recording medium to record images or data and a method for recording thereon.

### BACKGROUND ART

Rewritable recording technology has recently become the object of attention from the global environmental point of view. Advances in computer networks, communications technology, OA machines, recording media, and storage media are promoting paperless works in offices and homes.

Among substitutes of display media for printed matter is a reversible thermal recording medium capable of information writing and erasing by heat. This recording medium has come into practical use for prepaid card, reward card, credit card, and IC card, which contain the balance of accounts and other recorded information in visible and readable form. It is also finding use in the field of copying machines and printers.

Much has been mentioned of the above-mentioned reversible thermal recording medium and the method for recording, for example, Japanese Patent Laid-Open Nos. Hei 2-188293, Hei 2-188294, Hei-5-124360, Hei 7-108761, and Hei 7-188294.

These disclosures are concerned with a recording medium and a method for recording thereon, the recording medium having a recording layer of a resin matrix containing a leuco dye and a color developing-quenching agent. A leuco dye is an electron donating compound capable of color development.

The color developing-quenching agent may be an amphoteric compound having an acidic group that causes the leuco dye to develop color and a basic group that quenches the developed color of the leuco dye. It may also be a phenol compound having a long-chain alkyl group. The above-mentioned recording medium and recording method rely on the color development of the leuco dye, and hence they provide better contrast and visibility than those which rely on the dye of low-molecular weight dispersion type. They have been put to practical use in various fields of application.

The technologies in related art disclosed in the above-mentioned patent documents merely permit the recording medium to express two colors, one due to the ground and the other due to thermally induced discoloration. However, the new trend in recording media is toward expression with multicolor images or color-coded data for improved visibility and fashionability.

So, there have been proposed various methods for recording multicolor images with the foregoing technologies.

One example is a multicolor recording medium and a method for recording thereon which produces colors in such a way that a recording layer of low-molecular weight dispersion type makes multicolored layers or particles visible or invisible. (See Japanese Patent Laid-Open Nos. Hei 5-62189, Hei 8-80682, and 2000-198275.) The disadvantage of this multicolor-recording medium is that the recording layer does not completely hide the color of the underlying layer but allows the color of the base material to be seen through it. This results in low-contrast images.

There are some other disclosures about the reversible multicolor recording medium with a leuco dye. (See Japanese Patent Laid-Open Nos. Hei 8-58245 and 2000-25338, for example.) Unfortunately, it merely produces recorded images in very dark color or light color, because it has repeating units differing in color in its plane and each repeating unit used to record a specific color is limited in area.

There has also been disclosed a reversible multicolor recording medium which has separate, independent recording layers with leuco dyes differing in development temperature, quenching temperature, and cooling rate. (See, for example, Japanese Patent Laid-Open Nos. Hei 6-305247, Hei 6-328844, Hei 6-79970, Hei 8-164669, Hei 8-300825, Hei 9 52445, Hei 11-138997, 2001-162941, and 2002-59654.)

However, it poses a problem with difficulties in controlling the temperature of the heat source, such as thermal head and the like, and a problem with poor contrast and color fogging. Another disadvantage is that it is very hard to control three colors and more simply by operating the thermal head etc. at different temperatures and/or at different cooling rates after heating.

There is a disclosure about a method for making colored records in the reversible thermal multicolor recording medium having the recording layers of leuco dye formed separately and independently. Recording by this method is accomplished by heating an arbitrary recording layer by irradiation with a laser beam for light-heat conversion. (See Japanese Patent Laid-Open No. 2001-1645, for example.) The advantage of this method is that light-heat conversion is effective only for a certain recording layer which is selectively sensitive to specific wavelengths. Color development in this way will avoid color-fogging inherent in reversible multicolor recording medium in related art.

However, the technology in related art mentioned above lacks investigations into the light absorption characteristics of the infrared absorber, the relationship of the wavelength of the laser beam used for recording, and the relation between the laminating order of the recording layers and the laser beam used for irradiation. It has not yet completely solved the problem with color-fogging (which prevents the vivid development of any desired color). And it leaves room for improvement in recording sensitivity.

Moreover, there is an increasing need for improvement in the ability to reproduce intermediate colors other than the three primary colors. In other words, there is an increasing need for the multicolor recording medium capable of vivid full-color expression.

The recording medium disclosed in Japanese Patent Laid-Open No. 2001-1645 has a light-heat conversion layer (or a laser beam absorbing layer) which is formed by coating (without binder) from a light absorbing material dissolved in an organic solvent. Such a light-heat conversion layer absorbs laser beams over an extremely broad range of wavelengths, and this leads to an obscure expression. In addition, it also absorbs visible light and hence deteriorates the clarity of the recording layer in the extinct state. This leads to an obscure expression.

As mentioned above, there is a growing demand for multicolor thermal recording, on which active investigations are going on. Further improvement in recording characteristics is expected in the future.

The present invention was completed to address problems involved in the related art technology mentioned above. Thus it is an object of the present invention to provide a reversible multicolor thermal recording medium capable of full-color expression and a method for recording thereon, the recording medium producing clear images with a desired color tone (owing to distinct color development and quenching and high contrast without color fogging) repeatedly in a practically stable manner.

### DISCLOSURE OF INVENTION

The present invention covers a reversible multicolor recording medium which includes recording layers numbered from the first to the nth, which are formed on a supporting substrate side separately and independently in sequential order, the recording layers each containing a reversible thermal color developing composition differing from one another in the hue of the developed color and further containing a light-heat converting composition which generates heat upon absorption of near infrared rays with a wavelength in different ranges, and the recording layers having respectively the absorption peak wavelengths λ max 1, λ max 2, . . . , λ max n, in the near infrared region such that 1500 nm>λ max 1>λ max 2> . . . >λ max n>750 nm.

The present invention also covers a method for recording on a reversible multicolor recording medium by irradiation with arbitrary selected laser beams whose oscillation center wavelengths (λ₁, λ₂, . . . , λₙ) are in the range of 750 nm to 1500 nm, the reversible multicolor recording medium having recording layers numbered from the first to the nth, which are formed on a supporting substrate side separately and independently in sequential order, the recording layers each containing a reversible thermal color developing composition differing from one another in the hue of the developed color and further containing a light-heat converting composition which generates heat upon absorption of near infrared rays with a wavelength in different ranges, and the recording layers having respectively the absorption peak wavelengths λ max 1, λ max 2, . . . , λ max n, in the near infrared region such that 1500 nm>λ max 1>λ max 2> . . . >λ max n>750 nm.

The recording medium according to the present invention has a plurality of laminated recording layers, each having a specific absorption peak wavelength. The recording layers are selectively made to generate heat by irradiation with infrared rays of specific wavelength, so that the recording medium distinctly takes on the color-developed state and the color-quenched state.

### BRIEF DESCRIPTION OF DRAWINGS

FIG. 1 is a schematic sectional view showing one example of the reversible multicolor recording medium according to the present invention.

FIG. 2 is a schematic diagram showing the structure of one example of the recording layer.

FIG. 3 is a schematic diagram showing the structure of another example of the recording layer.

FIG. 4 is a schematic diagram showing the structure of another example of the recording layer.

FIG. 5 is a schematic diagram showing the structure of another example of the recording layer.

FIG. 6 is a graphical representation showing the absorption characteristics of the layer containing the light-heat converting composition.

FIG. 7 is a schematic sectional view showing another example of the reversible multicolor recording medium according to the present invention.

FIG. 8A is a schematic diagram showing the structure of the laminated recording layers as the major part of the reversible multicolor recording medium.

FIG. 8B is a graphical representation showing the absorption characteristics of each recording layer.

FIG. 9A is a schematic diagram showing the structure of the laminated recording layers as the major part of the reversible multicolor recording medium.

FIG. 9B is a graphical representation showing the absorption characteristics of each recording layer.

FIG. 10 is a graphical representation showing the absorption spectrum of typical dyes.

FIG. 11 is a graphical representation showing the absorption spectrum of typical dyes.

FIG. 12A is a schematic diagram showing the structure of the laminated recording layers as the major part of the reversible multicolor recording medium.

FIG. 12B is a graphical representation showing the absorption characteristics of each recording layer.

FIG. 13A is a schematic diagram showing the structure of the laminated recording layers as the major part of the reversible multicolor recording medium.

FIG. 13B is a graphical representation showing the absorption characteristics of each recording layer.

FIG. 14 is a graphical representation showing the absorption characteristics of each recording layer in the recording medium pertaining to Examples 1 to 4 and Comparative Example 1.

FIG. 15 is a graphical representation showing the absorption characteristics of each recording layer in the recording medium pertaining to Example 5.

FIG. 16 is a graphical representation showing the absorption characteristics of each recording layer in the recording medium pertaining to Example 6.

FIG. 17 is a graphical representation showing the absorption characteristics of each recording layer in the recording medium pertaining to Comparative Example 2.

FIG. 18 is a graphical representation showing the absorption characteristics of each recording layer in the recording medium pertaining to Comparative Example 3.

FIG. 19 is a graphical representation showing the absorption characteristics of each recording layer in the recording medium pertaining to Comparative Example 4.

FIG. 20 is a graphical representation showing the absorption characteristics of each recording layer in the recording medium pertaining to Comparative Example 5.

FIG. 21 is a graphical representation showing the absorption characteristics of each recording layer in the recording medium pertaining to Comparative Example 6.

FIG. 22 is a graphical representation showing the absorption characteristics of each recording layer in the recording medium pertaining to Comparative Example 7.

FIG. 23 is a graphical representation showing the absorption characteristics of each recording layer in the recording medium pertaining to Comparative Example 8.

FIG. 24 is a graphical representation showing the absorption characteristics of each recording layer in the recording medium pertaining to Comparative Example 9.

FIG. 25 is a graphical representation showing the absorption characteristics of each recording layer in the recording medium pertaining to Comparative Example 10.

FIG. 26 is a graphical representation showing the absorption characteristics of each recording layer in the recording medium pertaining to Comparative Example 11.

FIG. 27 is a graphical representation showing the absorption characteristics of each recording layer in the recording medium pertaining to Comparative Example 12.

### BEST MODE FOR CARRYING OUT THE INVENTION

The present invention will be described below in more detail with reference to some typical embodiments thereof in conjunction with the accompanying drawings; however, the scope of the present invention is not limited to the reversible multicolor recording medium and the method for recording thereon which are illustrated in the embodiments.

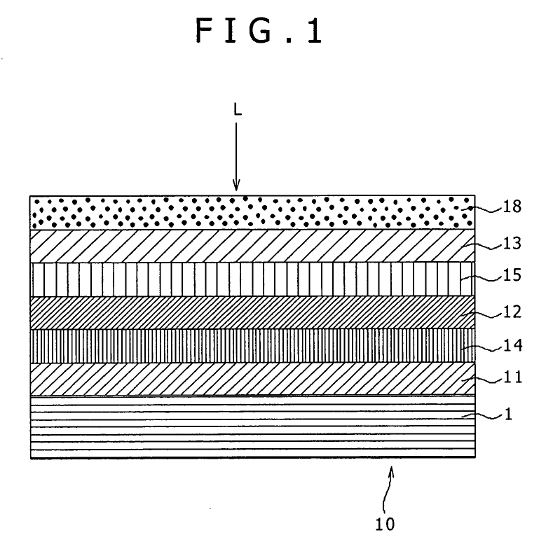

FIG. 1 is a schematic sectional view showing one example of the reversible multicolor recording medium according to the present invention.

A reversible multicolor recording medium 10 includes a supporting substrate 1 and “n” recording layers (three recording layers in this embodiment), a first recording layer 11, a second recording layer 12, and a third recording layer 13. These recording layers are formed on top of the other, with heat insulating layers 14 and 15 interposed between them and a protective layer 18 placed on the top.

The supporting substrate 1 may be formed from any known material which has good heat resistance and good dimensional stability in the plane direction. Such materials include polymers (such as polyester and rigid polyvinyl chloride), glass, metals (such as stainless steel), and paper. Preferable among these materials are those which assume a white color or a metallic color and have a high reflectivity for visible light. This is because the supporting substrate 1 should help the reversible multicolor recording medium 10 to exhibit good visibility except in the case where the recording medium 10 is used as a transparency for an overhead projector.

Each of the first to third recording layers 11 to 13 contains two compositions. One is a reversible thermal color developing composition that performs repeated stable recording by assuming the color-developed state and the color-quenched state, and the other is a light-heat converging composition which absorbs light in different regions of wavelength.

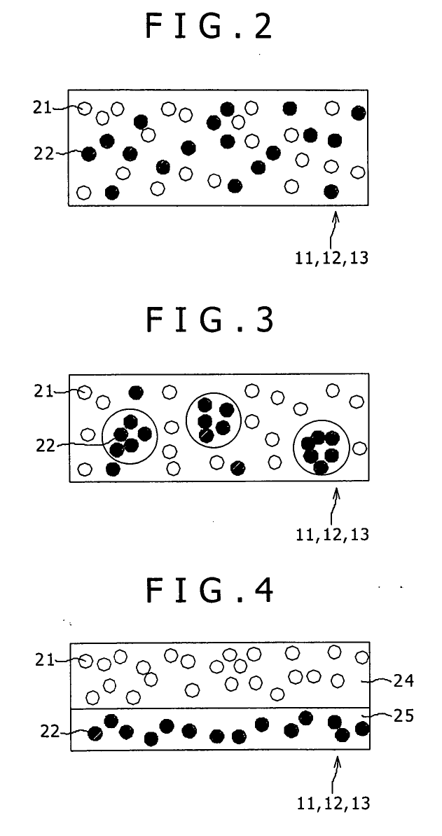

Each of the recording layers 11 to 13 may contain the reversible thermal color-developing composition 21 and the light-heat converting composition 22, which are mixed together as shown in FIG. 2 or which exist separately as shown in FIGS. 3 to 5.

The structure in which the reversible thermal color-developing composition 21 and the light-heat converting composition 22 exist separately as shown in FIG. 3 may be obtained by mixing them with respective resin binders which do not dissolve each other and mixing the resulting mixtures together. Alternatively, the object may be achieved by enclosing either of the two compositions in microcapsules 23 and dispersing them into the layer.

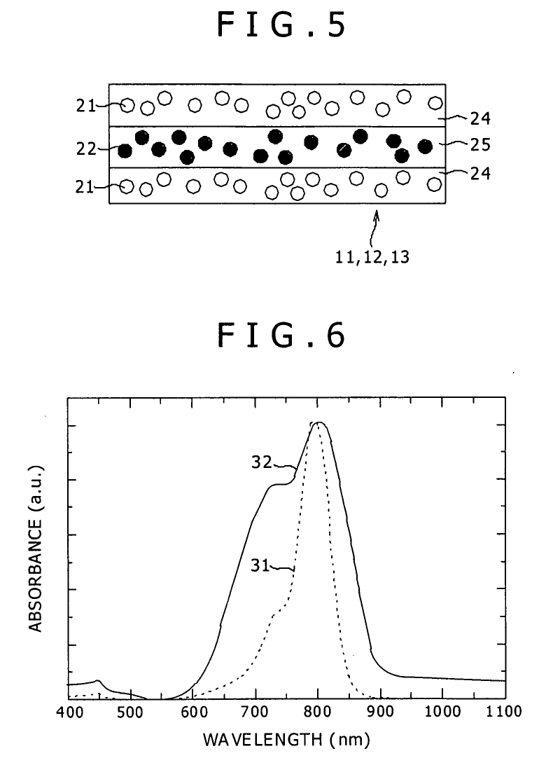

Another way is by lamination from separate layers each containing either of the two compositions, as shown in FIGS. 4 and 5.

The advantage of separating the reversible thermal color-developing composition 21 and the light-heat converting composition 22 from each other is that even when they interfere with each other the recording layers 11 to 13 accomplish color development and color quenching satisfactorily.

The first to third recording layers 11 to 13 should be formed with prescribed dyes according to the desired colors which they produce. For example, they may contain specific dyes that produce three primary colors of yellow, cyan, and magenta. Then the reversible multicolor recording medium 10 as a whole can produce full-color images.

The reversible thermal color-developing composition 21 mentioned above should contain an electron-donating coloring compound, which may be a leuco dye, for example, and an electron-accepting color-developing color-quenching agent. The leuco dye may be selected from existing dyes for pressure-sensitive paper and heat-sensitive paper.

The color-developing/color-quenching agent may be selected from the organic acids having long-chain alkyl groups which are disclosed in Japanese Patent Laid-Open Nos. Hei 5-124360, Hei 7-108761, Hei 7-188294, 2001-105733, and 2001-113829.

The light-heat converting composition 22 incorporated into the first to third recording layers 11 to 13 may be selected from infrared absorbing dyes having different absorption bands in the near infrared region.

The reversible multicolor recording medium 10 shown in FIG. 1 is characterized in that the recording layers 11 to 13 contain respectively different light-heat converting compositions to generate heat upon absorption of infrared rays with wavelengths of λ max 1, λ max 2, and λ max 3.

The range of the wavelengths is from 750 nm to 1500 nm because recording is accomplished with a laser beam. The light-heat converting composition contained in each of the recording layers decreases in absorption peak wavelength in going upward (from the lowermost layer adjacent to the supporting substrate 1 to the uppermost layer) such that 1500 nm>λ max 1>λ max 2>λ max 3>750 nm. This arrangement is intended to prevent color fogging and improve recording sensitivity, as mentioned later.

The light-heat converting composition contained in each of the recording layers 11 to 13 should preferably a dye that absorbs near infrared rays but rarely absorbs visible light. It includes, for example, metal complex dye, diimmonium dye, aminium dye, iminium salt dye, phthalocyanine dye, and polymethine dye.

In the case where each of the recording layers 11 to 13 is composed of a layer 24 (containing the reversible thermal color-developing composition) and a layer 25 (containing the light-heat converting composition) as shown in FIG. 4, it is desirable that the layer 25 be arranged next to the supporting substrate 1 and the layer 24 be arranged at the top that receives recording light.

The reason for this is that the layer 25 containing the light-heat converting composition gets hot upon irradiation with recording light L and that side of the layer 25 which receives recording light L gets hotter than the opposite side of the layer 25 according to Lambert-Beer's law. Thus the layer structure shown in FIG. 4 permits the layer 25 to give heat efficiently to the layer 24 containing the reversible thermal color-developing composition.

On the other hand, the layer structure shown in FIG. 2, which has a single recording layer containing the reversible thermal color-developing composition 21 and the light-heat converting composition 22 which are mixed together, offers the advantage of simplifying the manufacturing process. Also, the layer structure shown in FIGS. 3 to 5, in which the recording layer contains the compositions 21 and 22 separately and independently, offers the advantage of preventing their deterioration due to chemical reactions between them.

Incidentally, in the case of the layer structure shown in FIGS. 4 and 5, in which the layer 24 containing the reversible thermal color-developing composition 21 and the layer 25 containing the light-heat converting composition 22 are formed separately and independently, it is desirable that the light-heat converting composition 22 be uniformly dissolved in a prescribed resin binder.

The reason for this is as follows. If the light-heat converting composition 22 (or the infrared absorbing dye) in the layer 25 exists in its crystalline form or thin film without resin binder, it suffers coagulation and dimerization of dye and deteriorates in light absorbing characteristics (resulting in obscure absorption spectra in the infrared region).

The foregoing will be described with reference to FIG. 6 which shows the light absorption characteristics of a cyanine dye as an example of infrared absorbing dyes.

The curve 31 represents the absorption characteristics of a cyanine dye in layer form obtained from its mixture with a resin binder. The curve 32 represents the absorption characteristics of a cyanine dye in the form of thin film obtained by coating from a solution in an organic solvent and ensuing solvent evaporation.

It is noted that the cyanine dye mixed with a resin binder gives an extremely sharp absorption spectrum as indicated by the curve 31, whereas the cyanine dye in the form of thin film gives an absorption spectrum over a broad range of wavelengths as indicated by the curve 32. The latter case leads to color fogging that prevents clear recording. In addition, the absorption spectrum in the latter case covers the visible region, and this prevents the recording layer from restoring complete transparency after quenching.

It is necessary to select specific light-heat converting compositions each having a narrow absorption band which does not overlap its adjacent one, so that color development takes place only in a desired recording layer. Preferred examples of the light-heat converting composition which effectively protects the recording layer from color fogging include polymethine dyes (such as cyanine dye, squarilium dye, and croconium dye) and organic dyes composed mainly of phthalocyanine dye or naphthalocyanine dye.

However, it is not always necessary for the first recording layer 11 closest to the supporting substrate 1 to contain the above-mentioned organic dye having a narrow absorption band so long as it absorbs light passing through the recording layer above it.

The first to third recording layers 11 to 13 may contain a variety of additives that protect the light-heat converting composition from deterioration. Additives for polymethine dyes (as the light-heat converting composition) include metal complex dye, diimmonium salt dye, aminium salt dye, and ininium salt dye.

The recording layers 11 to 13 may be formed from any one of the following resins. Polyvinyl chloride, polyvinyl acetate, vinyl chloride-vinyl acetate copolymer, ethyl cellulose, polystyrene, styrene copolymer, phenoxy resin, polyester, aromatic polyester, polyurethane, polycarbonate, polyacrylic ester, polymethacrylic ester, acrylic acid copolymer, maleic acid copolymer, polyvinyl alcohol, modified polyvinyl alcohol, hydroxyethyl cellulose, carboxymethyl cellulose, and starch. If necessary, these resins may be incorporated with additives such as UV light absorber and antioxidant.

The first to third recording layers 11 to 13 are formed in the following way.

For the recording layers 11 to 13 each constructed as shown in FIG. 2, a coating compound is prepared by dissolving or dispersing in a prescribed resin the reversible thermal color-developing composition (composed of a leuco dye and a developing-quenching agent), the light-heat converting composition, and a variety of additives. Then, the coating compound is applied to a prescribed supporting substrate. Thus there is obtained the recording layers 11 to 13 as desired.

Each of the first to third recording layers 11 to 13 should have a thickness of about 1 to 15 μm, preferably about 1.5 to 8 μm. With an excessively small thickness, the recording layers do not produce the desired color density. With an excessively large thickness, the recording layers are poor in recording sensitivity (or the color developing and quenching performance) because of their large heat capacity.

For the recording layers 11 to 13 each constructed as shown in FIG. 3, a coating compound is prepared by dissolving or dispersing in two prescribed resins immiscible with each other the leuco dye, the developing-quenching agent, the light-heat converting composition, and a variety of additives. Alternatively, a coating compound is prepared by dispersing in prescribed solvent microcapsules containing the light-heat converting composition. Then, the coating compound is applied to a prescribed supporting substrate.

For the recording layers 11 to 13 each constructed as shown in FIG. 4 or 5, a coating compound is prepared by dissolving the light-heat converting composition 22 in a resin with the help of a solvent. Another coating compound is prepared by dissolving or dispersing the leuco dye, the developing-quenching agent, and a variety of additives in a resin with the help of a solvent. Then, the coating compounds are applied to a prescribed supporting substrate.

A precaution should be taken against intermixture of layers by selecting mutually immiscible resins for the layers 24 and 25 or by forming the upper layer after curing the underlying layer with heat or light.

Translucent heat-insulating layers 14 and 15 should preferably be interposed respectively between the first and second recording layers 11 and 12 and between the second and third recording layers 12 and 13. They prevent heat conduction across the adjacent recording layers, thereby avoiding so-called color fogging.

The heat-insulating layers 14 and 15 may be formed from any known translucent polymers, which include polyvinyl chloride, polyvinyl acetate, vinyl chloride-vinyl acetate copolymer, ethyl cellulose, polystyrene, styrene copolymer, phenoxy resin, polyester, aromatic polyester, polyurethane, polycarbonate, polyacrylic ester, polymethacrylic ester, acrylic acid copolymer, maleic acid copolymer, polyvinyl alcohol, modified polyvinyl alcohol, hydroxyethyl cellulose, carboxymethyl cellulose, and starch. They may be incorporated with UV light absorber and other additives according to need.

The heat-insulating layers 14 and 15 may also be formed from a translucent inorganic material, such as porous silica, alumina, titania, and carbon. They may be used in the composite form with a low coefficient of heat conduction. They may be formed into film from a liquid layer by sol-gel method.

The heat-insulating layers 14 and 15 should have a thickness of about 5 to 100 μm, preferably about 10 to 50 μm. Excessively thin heat-insulating layers do not provide sufficient thermal insulation, and excessively thick heat-insulating layers prevent light transmission and heat conduction (when the whole recording medium is uniformly heated as mentioned later).

Incidentally, the object of heat insulation between the recording layers may be effectively achieved by means of an air layer as disclosed in Japanese Patent Laid-Open No. 2001-1645. However, an air layer suffers the disadvantage of preventing heat conduction to the lower recording layer when the whole recording medium is uniformly heated to delete written information. The result is slow deletion or the necessity of heating at a high temperature which would deteriorate the recording medium or the supporting substrate.

In addition, the air layers would decrease mechanical strength necessary for the recording medium to resist bending and pressing. Moreover, the above-mentioned official gazette discloses the placement of a spacer between the recording layer and the air heat-insulating layer. The disadvantage of this structure is that the recording medium greatly fluctuates in sensitivity depending on the presence or absence of the spacer, which causes uneven or missing recording.

The protective layer 18 may be formed from any known thermoplastic resin or UV-curable resin. It should preferably have a thickness of about 0.5 to 50 μm.

An excessively thin protective layer will not produce the desired effect, and an excessively thick protective layer will prevent smooth heat conduction.

The reversible multicolor recording medium 10 shown in FIG. 1 accomplishes multicolor recording and erasing based on the principle mentioned in the following.

First, the recording medium is entirely heated at a temperature, say, about 120° C., which is high enough for quenching. This step clears the first to third recording layers 11 to 13 before recording. In this state, the reversible multicolor recording medium 10 assumes the color of the supporting substrate 1. Then, the recording medium is irradiated at its desired parts with a semiconductor infrared laser beam of specific wavelength and output.

For color development in the first recording layer 11, irradiation with infrared rays of wavelength in the neighborhood of λ max 1 is carried out with an energy sufficient for the first recording layer 11 to reach a temperature for its color development. Irradiation in this manner heats the light-heat converting composition and brings about the color-developing reaction between the color-forming compound (which is an electron donor) and the developing-quenching agent (which is an electron acceptor). In this way color development takes places at the irradiated parts.

In the same way as mentioned above, the second and third layers 12 and 13 are irradiated with laser beams each having a wavelength in the neighborhood of λ max 2 and λ max 3. The energy of irradiation is just enough for the respective recording layers to reach the temperature for color developing, so that the light-heat converting composition gets hot to bring about color development in the irradiated part.

Thus any specific part in the reversible multicolor recording medium 10 is made to assume any desired color. It will be possible for the recording medium to produce all the colors if there are as many laser sources (differing in oscillating wavelength band) as the recording layers each containing the light-heat converting material.

In addition, the reversible multicolor recording medium 10 will produce a mixture of colors originating from the recording layers if it is irradiated at the same spot with a laser beam having more than one wavelength. The mixed color will vary in tone if an adjustment is made to the energy of the laser beam for irradiation. In other words, if adequate arrangements are made so that the recording layers develop the colors of yellow, cyan, and magenta, respectively, the above-mentioned procedure permits the reversible multicolor recording medium 10 to record various images and information in full color.

The recorded images and information can be erased if the recording layers which have developed colors as mentioned above are uniformly heated to about 120° C. which is high enough for the colors of the first to third recording layers to quench. In this way it is possible to repeat recording.

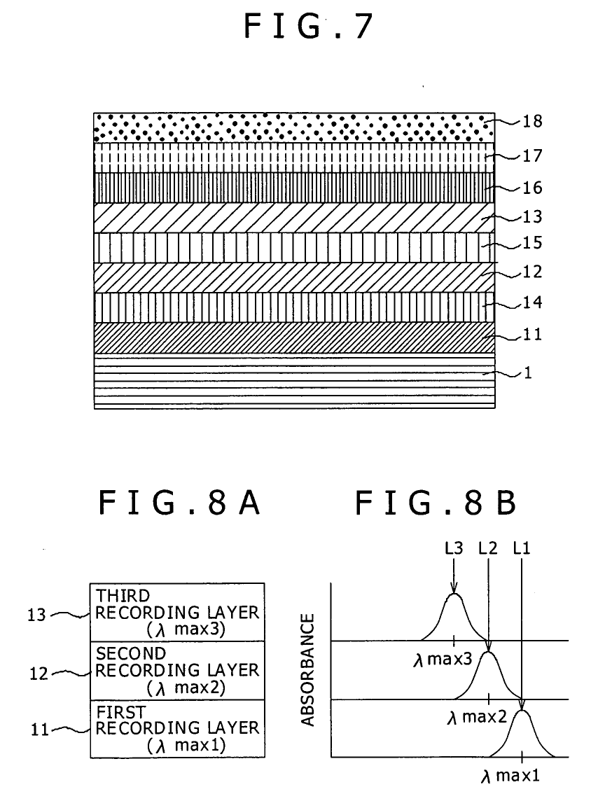

The reversible multicolor recording medium according to the present invention is not restricted to the one constructed as shown in FIG. 1. It may be modified as shown in FIG. 7. The modified one additionally has an upper recording layer 17 above the first to third recording layers. It contains a reversible thermal color-developing composition differing in color tone from that in the first to third recording layers.

Also, the upper recording layer 17 may not contain the light-heat converting composition. In this case, the recording and erasing of information is accomplished by means of a heat source of contact type, such as thermal head.

The reversible multicolor recording medium according to the present invention is not specifically restricted in the number of the recording layers. However, as the number of layers increases, the manufacturing process becomes more complex and the lower layers decrease in sensitivity and hence decrease in visibility in the visible region. In view of the fact that full-color display can be accomplished with three primary colors of yellow, cyan, and magenta, there is no need to use more than three layers.

However, for the displayed images to have improved clarity, it is desirable to add a recording layer which produces a black color. Thus the adequate number of the recording layers will be two to four layers.

In the case where two recording layers are used, their colors should be selected from black, blue, and red for good visibility.

In the case where three recording layers are used, their colors should be yellow, cyan, and magenta for full color recording.

In the case where four recording layers are used, their color should be yellow, cyan, magenta, and black. This is realized by adding the fourth recording layer 17 (with a heat-insulating layer 16 interposed thereunder) as shown in FIG. 7. The fourth recording layer does not contain the light-heat converting composition but develops a black color, so that it helps improve the visibility of full color images.

In the foregoing case, the laser beam for irradiation and the thermal head are used independently so that the lower three recording layers produce full color images and the upper fourth recording layer produces a black image as in a thermal printer.

For highly sensitive recording, the light-heat converting composition contained in the recording layers should have the optical characteristics as mentioned below.

The reversible multicolor recording medium according to the present invention is irradiated with laser beams in the near infrared region (750 to 1500 nm in wavelength) as the light for recording. For conversion from light into heat, the light-heat converting composition should absorb the light in that region of wavelength.

If visible light is used as the light for recording, the light-heat converting composition should be one capable of absorption in the visible region. In this case, the recording medium itself remains colored even after the reversible thermal color-developing composition has been quenched. This results in extremely poor visibility.

The foregoing applies to the case illustrated by Example in Japanese Patent Laid-Open No. 2001-1645, in which the light-heat converting composition is a dye that absorbs visible light of wavelength 655 nm. Such a dye causes the recording medium in its quenched state to absorb light in the red region, resulting in the ground color of the recording medium assuming blue, green, or light blue. This is considerably detrimental to visibility.

By contrast, the present invention employs light in the near infrared region for recording, and this makes it possible to use the light-heat converting composition which scarcely absorbs visible light. The result is very good visibility. Another advantage is adaptability to semiconductor laser (renowned for its low cost, small size, high output, and high-speed modulation) as the light source for recording.

The high-output semiconductor laser which is readily available for industrial use has the oscillation wavelength of approximately 780 to 810 nm, 830 nm, 850 to 870 nm, 910 to 920 nm, 930 to 940 nm, 980 nm, 1010 to 1060 nm, and 1470 nm. The laser beam for recording should be the one which has any one of the wavelengths listed above.

The reversible multicolor recording medium according to the present invention has the recording layers such that the reversible thermal color-developing composition contained therein should theoretically be colorless transparent in its quenched state.

However, in practice, the reversible thermal color-developing composition contained in the recording layers slightly absorbs visible light.

The reversible multicolor recording medium according to the present invention should have adequate brightness in its quenched state if it is to produce its maximum effect in full-color image recording. That is, the reflectivity of the ground plays an important role.

In view of the foregoing, the present inventors examined the reversible multicolor recording medium in its quenched state for the reflection density of the ground at peak wavelength for color development in the visible region. It was found that a light-heat converting composition with adequate absorption characteristics should be used in an adequate amount so that the ground has a reflection density lower than 0.6, if the recording medium as a whole is to exhibit good visibility with high contrast for each color.

To be specific, the reflection density of the ground should preferably be lower than 0.6 at the wavelengths of 460 nm, 550 nm, and 620 nm, in the reversible multicolor recording medium of three-layer structure as shown in FIG. 1, which has three recording layers, each developing yellow, magenta, and cyan colors at peak wavelengths of 460 nm, 550 nm, and 620 nm, respectively. The light-heat converting composition in each recording layer should have the absorption characteristics as mentioned in the following.

FIGS. 8A and 8B are schematic diagrams showing the absorption characteristics of the light-heat converting composition. FIG. 8A is a schematic diagram showing only the recording layers in the reversible multicolor recording medium of three-layer structure. FIG. 8B shows the absorption characteristics corresponding to each recording layer.

FIGS. 8A and 8B show the case in which the light-heat converting compositions for the recording layers 11 to 13 have the absorption bands the space between which is sufficiently narrower than that between the wavelengths L1, L2, and L3 of the laser beam to be used. In that case, the laser beams at individual wavelengths permit the recording layers 11 to 13 to develop desired colors independently for recording without color fogging.

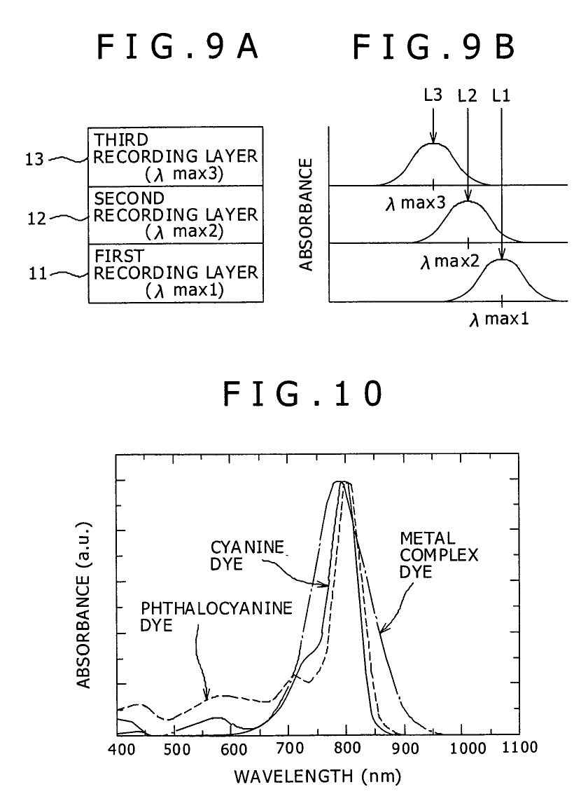

By contrast, there may be an instance in which the light-heat converting compositions for the recording layers 11 to 13 have the absorption band the space between which is wider than that of the wavelengths L1, L2, and L3 of laser beams used for recording, as shown in FIG. 9A (which is a schematic diagram illustrating the structure of the reversible multicolor recording medium) and in FIG. 9B (which is a diagram illustrating the absorption characteristics of each recording layer). In this instance (as shown in FIG. 9A), the third recording layer 13 absorbs the laser beam L2 at the time of recording in the second recording layer 12, thereby preventing the second recording layer 12 from being effectively heated. Moreover, the laser beam L2 brings about color development in the third recording layer 13, thereby resulting in color fogging.

Similarly, the upper layers absorb the laser beam at the time of recording in the first recording layer 11 shown in FIG. 9A. This hinders effective recording and causes color fogging.

Consequently, the light-heat converting compositions for the recording layers (except for at least the first recording layer 11) should be selected such that the space between their absorption bands is narrower than that between the wavelength of the laser beams used for recording.

It is concluded from the foregoing that the light-heat converting composition contained in the nth recording layer (numbered from the supporting substrate 1) should have the absorption characteristics Abs.n(λ) in the near infrared region of the wavelength λ such that its absorbance for the laser light for recording is lower than that of the laser beams (with wavelengths=λ₁, λ₂, . . . , λₙ₋₁) for the light-heat converting composition in the first, second, . . . , (n−1)th recording layers (which are under the nth recording layer). An absorbance smaller than 0.2 is practicable for the incident light to reach the desired recording layer.

With an absorbance larger than 0.2, the nth recording layer greatly reduces the amount of the laser beam reaching the lower recording layers (the first to (n−1)th recording layers). It also experiences color fogging, thereby assuming an undesirable color.

In other words, the absorption characteristics should be such that Abs.N(λ_{N-1}), . . . , Abs.N(λ₂), Abs.N(λ₁) <0.2, where N=2, 3, . . . , n.

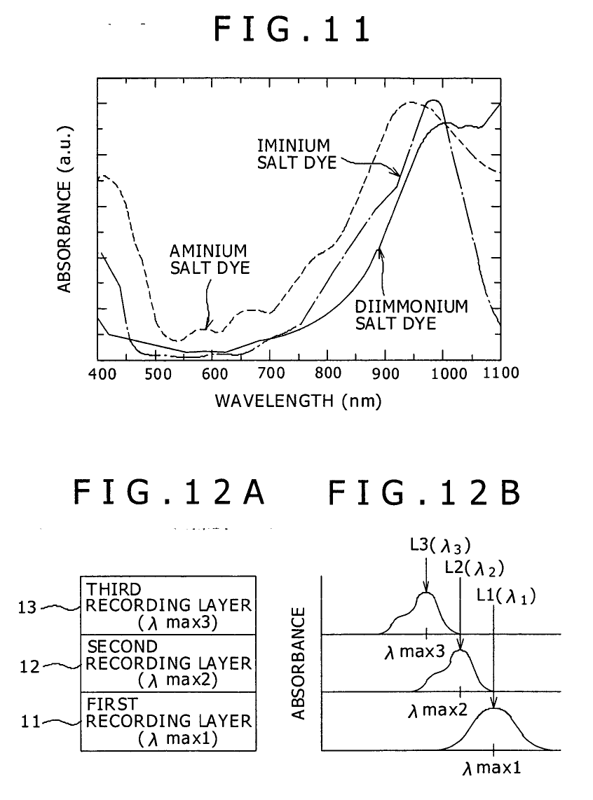

FIGS. 10 and 11 show the absorption spectra of typical dyes as the light-heat converting compositions.

It is apparent from FIGS. 10 and 11 that there are practically no dyes which absorb near infrared rays but scarcely absorb visible light (or which have extremely narrow absorption bands completely separate for the individual recording layers as shown in FIG. 8B). Thus it is necessary to contrive a special means for using the near infrared absorbing dye in order to perform highly sensitive recording without color fogging.

As shown in FIG. 10, among dyes suitable for use as the light-heat converting compositions in the recording medium are phthalocyanine dye, naphthalocyanine dye, cyanine dye, squarilium dye, and croconium dye, which have a very narrow absorption band in wavelengths beyond the absorption peak. Unfortunately, they also have dull absorption bands in the region of short wavelengths.

Nevertheless, it is possible to effectively avoid color fogging if the light-heat converting composition in the upper recording layers (except for at least the first recording layer 11) is selected from dyes having a very narrow absorption band in wavelength beyond the absorption peak as shown in FIG. 10 and if the wavelength of the absorption peak in each recording layer decreases in going from the lowermost layer (adjacent to the substrate) to the uppermost layer such that λ max 1>λ max 2> . . . >λ max n.

As shown in FIG. 12, the recording medium is irradiated with the laser beam L1 with a wavelength λ₁ at the time of recording in the first recording layer 11. However, this laser beam is scarcely absorbed by the second and third recording layers which have a very narrow absorption band in wavelength beyond the absorption peak. This permits efficient recording without color fogging.

For recording in the second recording layer 12, irradiation with the laser beam L2 of wavelength λ₂ is performed. This laser beam is scarcely absorbed by the third recording layer 13 and hence efficient recording is possible. In addition, it does not reach the first recording layer and hence does not cause color fogging if its wavelength is selected such that it is absorbed almost completely by the second recording layer.

Similarly, for recording in the third recording layer 13, irradiation with the laser beam L3 of wavelength λ₃ is performed. This laser beam does not reach the second and first recording layers and hence does not cause color fogging if its wavelength is selected such that it is absorbed almost completely by the third recording layer 13.

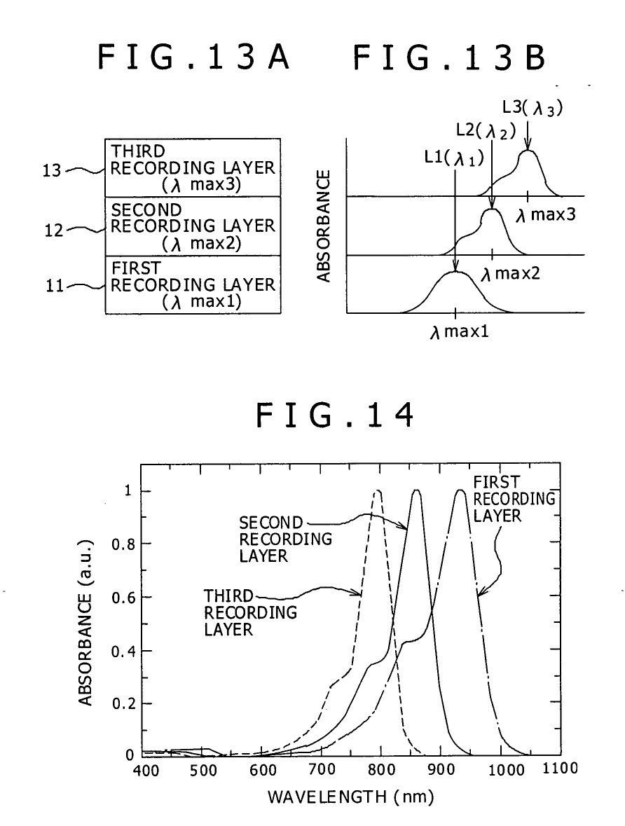

On the other hand, if the arrangement of the recording layers 11 to 13 shown in FIGS. 12A and 12B is reversed as shown in FIGS. 13A and 13B, in which the recording layer having the absorption peak in the region of short wavelengths is formed low such that λ max 1<λ max 2< . . . <λ max n, then the laser beam for recording is absorbed by the upper recording layers before it reaches the recording layer in which recording is to be made. This causes color fogging and decreases the recording sensitivity of the lower recording layers.

As mentioned above, when the recording medium is irradiated with a laser beam of wavelength λ₃ for recording in the third recording layer 13, the laser beam should be sufficiently absorbed by the light-heat converting composition contained in the third recording layer 13; otherwise, the laser beam of wavelength λ₃ passes through the third recording layer 13 and reaches the second and first recording layers 12 and 11 to bring about color development in them, thereby causing color fogging and deteriorating recording efficiency. The same applies to the absorption characteristics of the light-heat converting composition contained in other recording layers.

Incorporation with the light-heat converting composition (dye) in large quantities to increase the absorptivity of the upper recording layer thereby preventing the layer beam from reaching the lower recording layers remarkably increases the absorption of visible light in that recording layer thereby deteriorating the visibility of the recording medium.

It follows from the foregoing that the recording layers should have absorbance in a specific range so that it performs clear reliable recording while keeping good visibility.

It was concluded from a practical point of view that the absorbance Abs.N(λ_{N}) of the light-heat converting composition contained in the recording layer for recording with a laser beam of wavelength λ_{N} should meet the condition 1.5>Abs.N(λ_{N})>0.6, where N=2, . . . , n.

This conclusion is based on the following reasoning. Any recording layer having an absorbance no larger than 0.6 for the wavelength of the laser beam to make recording is practically poor in recording efficiency, and it permits about 25% of the light for recording to reach the lower recording layers, thereby causing color fogging.

On the other hand, any recording layer having an absorbance no smaller than 1.5 for the wavelength of the laser beam to make recording absorbs much of the light to be used for recording in the lower recording layers, resulting in the loss of irradiated light. This is because the light to be absorbed by that recording layer has an excessively broad range of wavelength.

If the light-heat converting composition is a cyanine dye, it does not remarkably increase in the amount of light to be absorbed by the recording layer even though it has an absorbance larger than 1.5 for the near infrared light for recording. Therefore, its absorbance should preferably be smaller than 1.5 in consideration of cost.

As the light to be absorbed by the recording layer increases in the range of wavelength as mentioned above, it also absorbs more visible light significantly, thereby reducing the visibility.

The foregoing suggests that the Nth recording layer (numbered from the one adjacent to the supporting substrate 1) should preferably contain a light-heat converting composition whose absorbance Abs.N(λ_{N}) for the laser beam of wavelength λ_{N} for recording meets the condition 1.5>Abs.N(λ_{N})>0.6, where N=2, . . . , n.

The foregoing, however, does not apply to the first recording layer 11 adjacent to the supporting substrate 1, because there is no recording layer under supporting substrate 1 side and hence it is meaningless to specify the upper limit of the absorbance from the standpoint of the loss of recording light. Thus the light-heat converting composition in the first recording layer 11 will be satisfactory if it has an absorbance Abs.1(λ₁)>0.6 for the laser beam of wavelength λ₁ that makes recording.

For the near infrared absorbing dye (as the light-heat converting composition) to be used as little as possible and to meet the above-mentioned conditions 1.5>Abs.N(λ_{N})>0.6 (where N=2, . . . , n) and Abs.1(λ₁)>0.6, it is necessary that the absorption peak wavelength λ max N in the near infrared region of the near infrared absorbing dye should coincide with the wavelength λ_{N} of the laser beam to make recording in the corresponding recording layer, or λ max N=λ_{N} (N=1, 2, . . . , n).

Unfortunately, it is extremely difficult to control the absorption band of the dye and the oscillating wavelength of the laser beam completely and theoretically as mentioned above.

Particularly, it is extremely difficult to achieve the above-mentioned object because semiconductor laser devices vary in oscillation wavelengths depending on fabricating condition and operating environment.

Thus, one way to overcome the above-mentioned practical difficulties is by establishing both wavelengths such that (λ max N−15 nm)<λ_{N}<(λ max N+20 nm).

The reason for this explained in the following.

It was found that phthalocyanine dyes and cyanine dyes, which are suitable for use as the light-heat converting composition, have the absorption characteristics such that they do not vary significantly in amount and sensitivity if the laser beam for recording has a wavelength which is longer or shorter than the absorption peak wavelength by about 20 nm.

However, if the wavelength for recording by the dye is shorter than the absorption peak wavelength, the dye absorbs the laser beam to make record in the lower recording layer, thereby causing color fogging and making the lower layer to decrease in sensitivity. Therefore, the wavelength of the laser beam for recording should preferably be the one which is shorter or longer by about 15 nm than the absorption peak wavelength of the light-heat converting composition.

The foregoing, however, does not necessarily apply to the first recording layer 11 adjacent to the supporting substrate 1 because there are no recording layers thereunder.

Accordingly, the present invention specifies both wavelengths such that (λ max N−15 nm)<λ_{N}<(λ max N+20 nm), where N=2, . . . , n.

In the case where the light-heat converting composition is selected from phthalocyanine dyes, naphthalocyanine dyes, cyanine dyes, squarilium dyes, and croconium dyes, which have an absorption band in the near infrared region, the laser beam for recording should have the oscillation center wavelength which is no less than 40 nm, preferably no less than 60 nm, away from the wavelength of their absorption band. It was found that this is necessary to completely prevent color fogging.

### EXAMPLES

The invention will be described below in more detail with reference to the following examples and comparative examples, which are not intended to restrict the scope thereof.

Each of coating compounds 1 to 28 was prepared from the following materials by mixing and crushing (into particles no more than 0.3 μm) by using a paint conditioner.

[Coating Compound 1]

Coating compound 1 was prepared from the following materials by mixing and crushing (into particles no more than 0.3 μm) by using a paint conditioner.

Leuco dye that produces a cyan color: 1.5 pbw

(“H3035” from YAMADA CHEMICAL CO., LTD., represented by chemical formula (1) below)

(Chemical Formula 1)

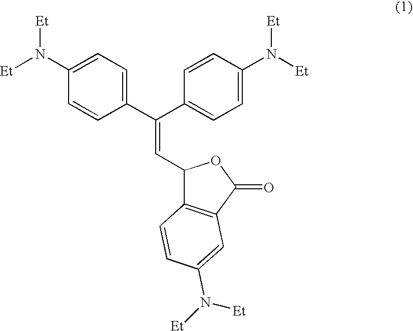

4-hydroxystearylurea represented by chemical formula (2) below: 4 pbw

(Chemical Formula 2)

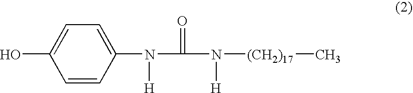

Chloride-vinyl/acetate-vinyl/alcohol-vinyl polymer: 5 pbw

(91%/3%/6%, average molecular weight=70,000)

MEK (methyl ethyl ketone): 95 pbw

Cyanine dye with a peak at 933 nm in the recording layer

“SDA 7775” from H. W. SANDS CORP.): 0.18 pbw

[Coating Compound 2]

Coating compound 2 was prepared from the following materials by mixing and crushing (into particles no more than 0.3 μm) by using a paint conditioner.

Leuco dye that produces a magenta color: 1.5 pbw

(“Red-DCF” from HODOGAYA CHEMICAL CO.,LTD., represented by chemical formula (3) below)

(Chemical Formula 3)

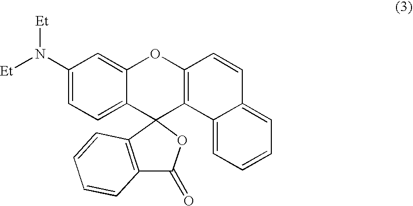

4-hydroxystearylurea represented by chemical formula (2) below: 4 pbw

(Chemical Formula 4)

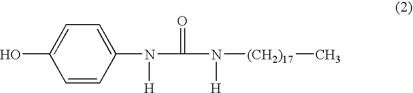

Chloride-vinyl/acetate-vinyl/alcohol-vinyl polymer: 5 pbw

(91%/3%/6%, average molecular weight=70,000)

MEK: 95 pbw

Cyanine dye with a peak at 860 nm in the recording layer, represented by chemical formula (4) below: 0.12 pbw

(Chemical Formula 5)

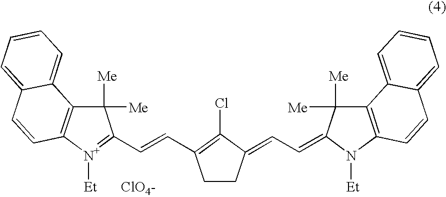

[Coating Compound 3]

Leuco dye that produces a yellow color: 1.5 pbw

(represented by chemical formula (5) below, disclosed in Japanese Patent Publication No. Hei 3-11634)

(Chemical Formula 6)

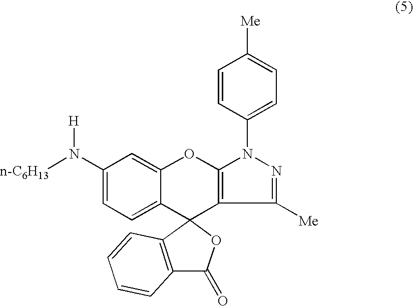

4-hydroxystearylurea represented by chemical formula (2) below: 4 pbw

(Chemical Formula 7)

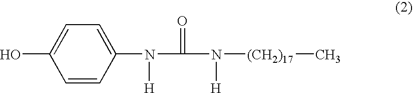

Chloride-vinyl/acetate-vinyl/alcohol-vinyl polymer: 5 pbw

(91%/3%/6%, average molecular weight=70,000)

MEK: 95 pbw

Cyanine dye with a peak at 798 nm in the recording layer, represented by chemical formula (6) below: 0.1 pbw

(Chemical Formula 8)

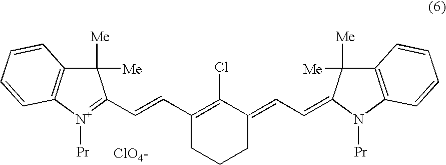

[Coating Compound 4]

Coating compound 4 was prepared in the same way as mentioned above except that the cyanine dye used for coating compound 1 was replaced by a nickel complex dye (represented by chemical formula (7) below) having an absorption peak of 940 nm in the recording medium. The amount of the dye was 0.6 pbw.

(Chemical Formula 9)

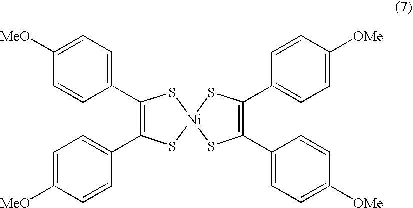

[Coating Compound 5]

Coating compound 5 was prepared in the same way as mentioned above except that the amount of the cyanine dye used for coating compound 2 was changed to 0.24 pbw.

[Coating compound 6]

Coating compound 6 was prepared in the same way as mentioned above except that the cyanine dye used for coating compound 3 was replaced by a phthalocyanine dye (“YKR 3070” from Yamamoto Chemical Industry) having an absorption peak of 800 nm in the recording medium. The amount of the dye was 0.36 pbw.

[Coating Compound 7]

Coating compound 7 was prepared in the same way as mentioned above except that the cyanine dye used for coating compound 1 was replaced by a cyanine dye (represented by chemical formula (4) below) having an absorption peak of 860 nm in the recording medium. The amount of the dye was 0.12 pbw.

(Chemical Formula 10)

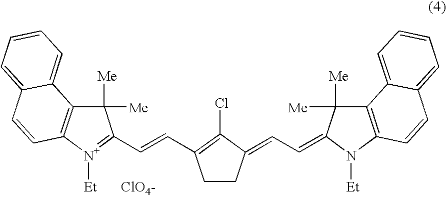

[Coating Compound 8]

Coating compound 8 was prepared in the same way as mentioned above except that the amount of the cyanine dye used for coating compound 2 was changed to 0.06 pbw.

[Coating Compound 9]

Coating compound 9 was prepared in the same way as mentioned above except that the amount of the cyanine dye used for coating compound 3 was changed to 0.2 pbw.

[Coating Compound 10]

Coating compound 10 was prepared in the same way as mentioned above except that the amount of the cyanine dye used for coating compound 3 was changed to 0.05 pbw.

[Coating compound 11]

Coating compound 11 was prepared in the same way as mentioned above except that the cyanine dye used for coating compound 2 was replaced by a cyanine dye (represented by chemical formula (8) below) having an absorption peak of 830 nm in the recording medium. The amount of the dye was 0.12 pbw.

(Chemical Formula 11)

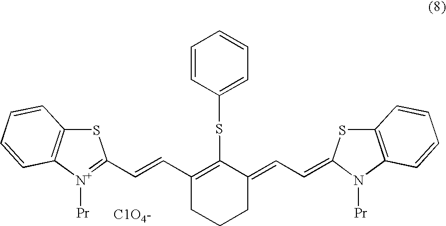

[Coating Compound 12]

Coating compound 12 was prepared in the same way as mentioned above except that the cyanine dye used for coating compound 2 was replaced by a cyanine dye (represented by chemical formula (9) below) having an absorption peak of 870 nm in the recording medium. The amount of the dye was 0.13 pbw.

(Chemical Formula 12)

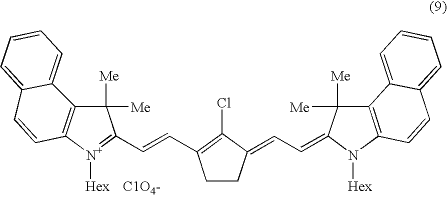

[Coating Compound 13]

Coating compound 13 was prepared in the same way as mentioned above except that the cyanine dye used for coating compound 2 was replaced by a cyanine dye (represented by chemical formula (10) below) having an absorption peak of 880 nm in the recording medium. The amount of the dye was 0.16 pbw.

(Chemical Formula 13)

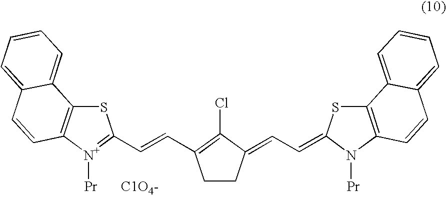

[Coating Compound 14]

Coating compound 14 was prepared in the same way as mentioned above except that the cyanine dye used for coating compound 2 was replaced by a cyanine dye (represented by chemical formula (11) below) having an absorption peak of 845 nm in the recording medium. The amount of the dye was 0.16 pbw.

(Chemical Formula 14)

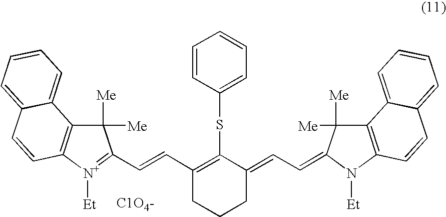

[Coating Compound 15]

Coating compound 15 was prepared in the same way as mentioned above except that the cyanine dye used for coating compound 2 was replaced by a cyanine dye (represented by chemical formula (12) below) having an absorption peak of 835 nm in the recording medium. The amount of the dye was 0.22 pbw.

(Chemical Formula 15)

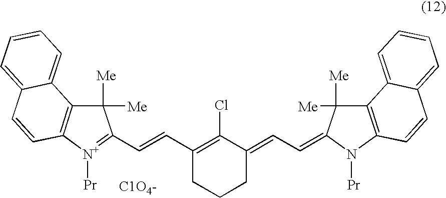

[Coating Compound 16]

Coating compound 16 was prepared in the same way as mentioned above except that the cyanine dye used for coating compound 1 was replaced by an iminium salt dye (represented by chemical formula (13) below) having an absorption peak of 980 nm in the recording medium. The amount of the dye was 0.45 pbw.

(Chemical Formula 16)

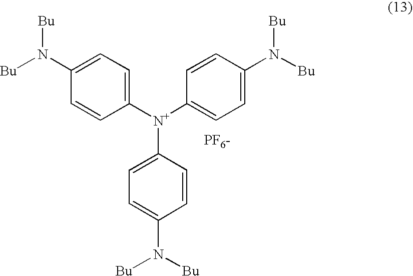

[Coating Compound 17]

Coating compound 17 was prepared in the same way as mentioned above except that the cyanine dye used for coating compound 2 was replaced by,a nickel complex dye (represented by chemical formula (14) below) having an absorption peak of 865 nm in the recording medium. The amount of the dye was 0.6 pbw.

(Chemical Formula 17)

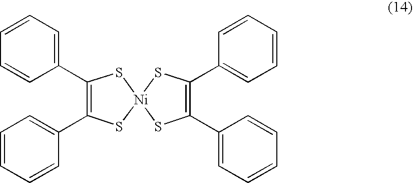

[Coating Compound 18]

Coating compound 18 was prepared in the same way as mentioned above except that the cyanine dye used for coating compound 3 was replaced by a nickel complex dye (represented by chemical formula (15) below) having an absorption peak of 780 nm in the recording medium. The amount of the dye was 0.6 pbw.

(Chemical Formula 18)

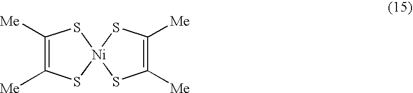

[Coating Compound 19]

Coating compound 19 was prepared from the following materials by mixing and crushing (into particles no more than 0.3 μm) by using a paint conditioner and then mixing with 50 pbw of 7.5 wt % aqueous solution of polyvinyl alcohol.

Leuco dye that produces a cyan color: 1.5 pbw

(“H3035” from YAMADA CHEMICAL CO., LTD., represented by chemical formula (1) below)

(Chemical Formula 19)

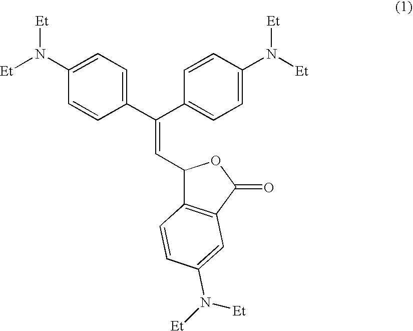

4-hydroxystearylurea represented by chemical formula (2) below: 4 pbw

(Chemical Formula 20)

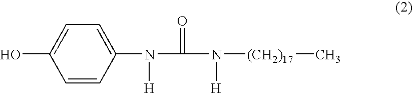

2.5 wt % aqueous solution of polyvinyl alcohol: 50 pbw

[Coating Compound 20]

Coating compound 20 was prepared from the following materials by mixing and crushing (into particles no more than 0.3 μm) by using a paint conditioner and then mixing with 50 pbw of 7.5 wt % aqueous solution of polyvinyl alcohol.

Leuco dye that produces a magenta color: 1.5 pbw

(“Red-DCF” from HODOGAYA CHEMICAL CO.,LTD., represented by chemical formula (3) below)

(Chemical Formula 21)

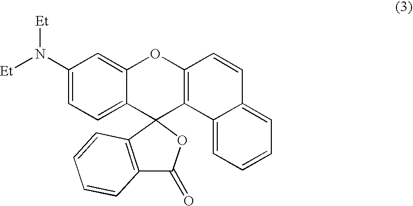

4-hydroxystearylurea represented by chemical formula (2) below: 4 pbw

(Chemical Formula 22)

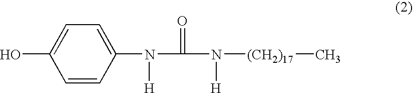

2.5 wt % aqueous solution of polyvinyl alcohol: 50 pbw

[Coating Compound 21]

Coating compound 21 was prepared from the following materials by mixing and crushing (into particles no more than 0.3 μm) by using a paint conditioner and then mixing with 50 pbw of 7.5 wt % aqueous solution of polyvinyl alcohol.

Leuco dye that produces a yellow color: 1.5 pbw

represented by chemical formula (5) below, disclosed in Japanese Patent Publication No. Hei 3-11634

(Chemical Formula 23)

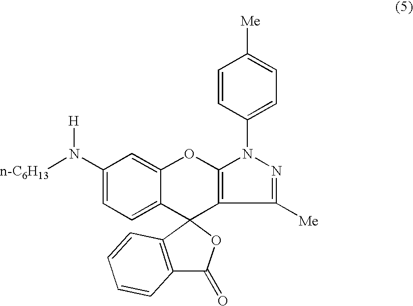

4-hydroxystearylurea represented by chemical formula (2) below: 4 pbw

(Chemical Formula 24)

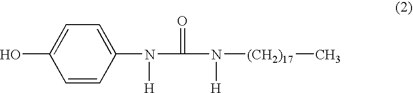

2.5 wt % aqueous solution of polyvinyl alcohol: 50 pbw

[Coating Compound 22]

Coating compound 22 was prepared by mixing from the following materials.

Cyanine dye having an absorption peak of 933 nm in a resin: 0.18 pbw (“SDA 7775” from H. W. SANDS CORP.)

Chloride-vinyl/acetate-vinyl/alcohol-vinyl polymer: 5 pbw

(91%/3%/6%, average molecular weight=70,000)

THF: 95 pbw

[Coating Compound 23]

Coating compound 23 was prepared by mixing from the following materials.

Cyanine dye (represented by chemical formula (4) below having an absorption peak of 860 nm in a resin: 0.12 pbw

(Chemical Formula 25)

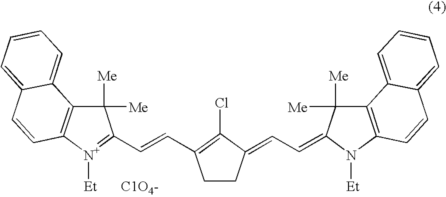

Chloride-vinyl/acetate-vinyl/alcohol-vinyl polymer: 5 pbw

(91%/3%/6%, average molecular weight=70,000)

THF: 95 pbw

[Coating Compound 24]

Coating compound 24 was prepared by mixing from the following materials.

Cyanine dye (represented by chemical formula (6) below having an absorption peak of 798 nm in a resin: 0.1 pbw

(Chemical Formula 26)

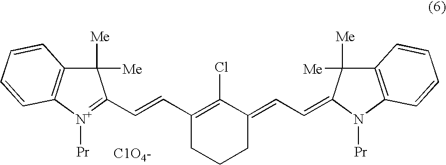

Chloride-vinyl/acetate-vinyl/alcohol-vinyl polymer: 5 pbw

(91%/3%/6%, average molecular weight=70,000)

THF: 95 pbw

[Coating Compound 25]

Coating compound 25 was prepared from the following materials by mixing and crushing (into particles no more than 0.3 μm) by using a paint conditioner.

Leuco dye that produces a black color: 1.5 pbw

represented by chemical formula (16) below; “BLACK-15” from Yamamoto Chemicals, Inc.

(Chemical Formula 27)

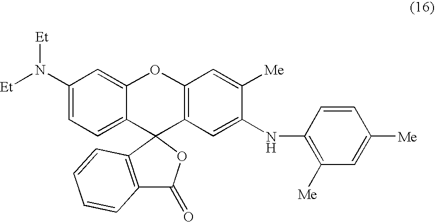

4 -hydroxystearylurea represented by chemical formula (2) below: 4 pbw

(Chemical Formula 28)

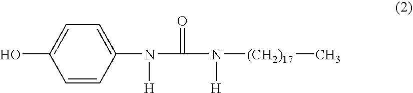

Chloride-vinyl/acetate-vinyl/alcohol-vinyl polymer: 5 pbw

(91%/3%/6%, average molecular weight=70,000)

MEK: 95 pbw

[Coating Compound 26]

Coating compound 26 was prepared in the same way as mentioned above except that the cyanine dye used for coating compound 1 was replaced by a cyanine dye (represented by chemical formula (6) below) having an absorption peak of 798 nm in the recording medium. The amount of the dye was 0.1 pbw.

(Chemical Formula 29)

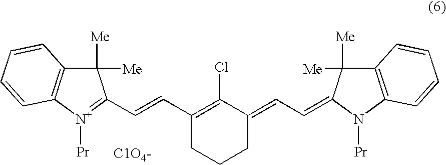

[Coating Compound 27]

Coating compound 27,was prepared in the same way as mentioned above except that the cyanine dye used for coating compound 3 was replaced by a cyanine dye (“SDA 7775” from H. W. SANDS CORP.) having an absorption peak of 933 nm in the recording medium. The amount of the dye was 0.18 pbw.

[Coating Compound 28]

A 10 wt % solution of polyvinyl alcohol in a 9/1 mixture of water and ethanol was used as coating compound 28.

A sample of the reversible multicolor recording medium was prepared which has the recording layer and heat-insulating layer formed from any one of the above-mentioned coating compounds 1 to 28. In the following examples, the recording layer was formed from each coating compound by coating and ensuing drying with a wire bar, unless otherwise mentioned.

### Example 1

(CMY (Cyan, Magenta, Yellow) Standard Type)

Supporting substrate: white polyethylene terephthalate (1 mm thick)

The first recording layer: coating compound 1 (4 μm thick)

Heat insulting layer: coating compound 28 (30 μm thick)

The second recording layer: coating compound 2 (4 μm thick)

Heat insulating layer: coating compound 28 (30 μm thick)

The third recording layer: coating compound 3 (4 μm thick)

Protective layer: UV curable resin (5 μm thick)

### Example 2

(CMYBK (Cyan, Magenta, Yellow, Black) Standard Type, (Laser Plus Thermal))

Supporting substrate: white polyethylene terephthalate (1 mm thick)

The first recording layer: coating compound 1 (4 μm thick)

Heat insulting layer: coating compound 28 (30 μm thick)

The second recording layer: coating compound 2 (4 μm thick)

Heat insulating layer: coating compound 28 (30 μm thick)

The third recording layer: coating compound 3 (4 μm thick)

Heat insulating layer: coating compound 28 (30 μm thick)

The fourth recording layer: coating compound 25 (4 μm thick)

Protective layer: UV curable resin (5 μm thick)

### Example 3

((Absorbing Particles Plus Color Developing Layer) Standard Type)

Each of coating compounds 22, 23, and 24 was sprayed by using a spray drier to give particles having an average particle size of 0.3 μm.

Supporting substrate: white polyethylene terephthalate (1 mm thick)

The first recording layer: formed from a 1/9 mixture of the particles (of coating compound 22) and coating compound 19 (4 μm thick)

Heat insulting layer: coating compound 28 (30 μm thick)

The second recording layer: formed from a 1/9 mixture of the particles (of coating compound 23) and coating compound 20 (4 μm thick)

Heat insulating layer: coating compound 28 (30 μm thick)

The third recording layer: formed from a 1/9 mixture of the particles (of coating compound 24) and coating compound 21 (4 μm thick)

Protective layer: UV curable resin (5 μm thick)

### Example 4

((Absorbing Layer Plus Color Developing Layer) Standard Type)

Supporting substrate: white polyethylene terephthalate (1 mm thick)

The first recording layer: composed of coating compound 22 (2 μm thick) and coating compound 19 (6 μm thick) placed thereon.

Heat insulting layer: coating compound 28 (30 μm thick)

The second recording layer: composed of coating compound 23 (2 μm thick) and coating compound 20 (6 μm thick) placed thereon.

Heat insulating layer: coating compound 28 (30 μm thick)

The third recording layer: composed of coating compound 24 (2 μm thick) and coating compound 21 (6 μm thick) placed thereon.

Protective layer: UV curable resin (5 μm thick)

### Example 5

Supporting substrate: white polyethylene terephthalate (1 mm thick)

The first recording layer: coating compound 1 (4 μm thick)

Heat insulting layer: coating compound 28 (30 μm thick)

The second recording layer: coating compound 12 (4 μm thick)

Heat insulating layer: coating compound 28 (30 μm thick)

The third recording layer: coating compound 3 (4 μm thick)

Protective layer: UV curable resin (5 μm thick)

### Example 6

Supporting substrate: white polyethylene terephthalate (1 mm thick)

The first recording layer: coating compound 1 (4 μm thick)

Heat insulting layer: coating compound 28 (30 μm thick)

The second recording layer: coating compound 14 (4 μm thick)

Heat insulating layer: coating compound 28 (30 μm thick)

The third recording layer: coating compound 3 (4 μm thick)

Protective layer: UV curable resin (5 μm thick)

### Comparative Example 1

Supporting substrate: white polyethylene terephthalate (1 mm thick)

The first recording layer: composed of coating compound 19 (6 μm thick) and coating compound 22 (2 μm thick) placed thereon.

Heat insulting layer: coating compound 28 (30 μm thick)

The second recording layer: composed of coating compound 20 (6 μm thick) and coating compound 23 (2 μm thick) placed thereon.

Heat insulating layer: coating compound 28 (30 μm thick)

The third recording layer: composed of coating compound 21 (6 μm thick) and coating compound 24 (2 μm thick) placed thereon.

Protective layer: UV curable resin (5 μm thick)

### Comparative Example 2

Supporting substrate: white polyethylene terephthalate (1 mm thick)

The first recording layer: composed of cyanine dye thin film (formed from a methanol solution of cyanine dye “SDA 7775” from H. W. SANDS CORP.) and coating compound 19 (6 μm thick) placed thereon.

Heat insulting layer: coating compound 28 (30 μm thick)

The second recording layer: composed of cyanine dye thin film (formed from an acetone solution of cyanine dye represented by chemical formula (4)) and coating compound 20 (6 μm thick) placed thereon.

Heat insulating layer: coating compound 28 (30 μm thick)

The third recording layer: composed of cyanine dye thin film (formed from an acetone solution of cyanine dye represented by chemical formula (6)) and coating compound 21 (6 μm thick) placed thereon.

Protective layer: UV curable resin (5 μm thick)

### Comparative Example 3

Supporting substrate: white polyethylene terephthalate (1 mm thick)

The first recording layer: coating compound 16 (4 μm thick)

Heat insulting layer: coating compound 28 (30 μm thick)

The second recording layer: coating compound 17 (4 μm thick)

Heat insulating layer: coating compound 28 (30 μm thick)

The third recording layer: coating compound 18 (4 μm thick)

Protective layer: UV curable resin (5 μm thick)

### Comparative Example 4

Supporting substrate: white polyethylene terephthalate (1 mm thick)

The first recording layer: coating compound 26 (4 μm thick)

Heat insulting layer: coating compound 28 (30 μm thick)

The second recording layer: coating compound 2 (4 μm thick)

Heat insulating layer: coating compound 28 (30 μm thick)

The third recording layer: coating compound 27 (4 μm thick)

Protective layer: UV curable resin (5 μm thick)

### Comparative Example 5

Supporting substrate: white polyethylene terephthalate (1 mm thick)

The first recording layer: coating compound 4 (4 μm thick)

Heat insulting layer: coating compound 28 (30 μm thick)

The second recording layer: coating compound 2 (4 μm thick)

Heat insulating layer: coating compound 28 (30 μm thick)

The third recording layer: coating compound 6 (4 μm thick)

Protective layer: UV curable resin (5 μm thick)

### Comparative Example 6

Supporting substrate: white polyethylene terephthalate (1 mm thick)

The first recording layer: coating compound 7 (4 μm thick)

Heat insulting layer: coating compound 28 (30 μm thick)

The second recording layer: coating compound 11 (4 μm thick)

Heat insulating layer: coating compound 28 (30 μm thick)

The third recording layer: coating compound 3 (4 μm thick)

Protective layer: UV curable resin (5 μm thick)

### Comparative Example 7

Supporting substrate: white polyethylene terephthalate (1 mm thick)

The first recording layer: coating compound 1 (4 μm thick)

Heat insulting layer: coating compound 28 (30 μm thick)

The second recording layer: coating compound 13 (4 μm thick)

Heat insulating layer: coating compound 28 (30 μm thick)

The third recording layer: coating compound 3 (4 μm thick)

Protective layer: UV curable resin (5 μm thick)

### Comparative Example 8

Supporting substrate: white polyethylene terephthalate (1 mm thick)

The first recording layer: coating compound 1 (4 μm thick)

Heat insulting layer: coating compound 28 (30 μm thick)

The second recording layer: coating compound 15 (4 μm thick)

Heat insulating layer: coating compound 28 (30 μm thick)

The third recording layer: coating compound 3 (4 μm thick)

Protective layer: UV curable resin (5 μm thick)

### Comparative Example 9

Supporting substrate: white polyethylene terephthalate (1 mm thick)

The first recording layer: coating compound 1 (4 μm thick)

Heat insulting layer: coating compound 28 (30 μm thick)

The second recording layer: coating compound 5 (4 μm thick)

Heat insulating layer: coating compound 28 (30 μm thick)

The third recording layer: coating compound 3 (4 μm thick)

Protective layer: UV curable resin (5 μm thick)

### Comparative Example 10

Supporting substrate: white polyethylene terephthalate (1 mm thick)

The first recording layer: coating compound 1 (4 μm thick)

Heat insulting layer: coating compound 28 (30 μm thick)

The second recording layer: coating compound 8 (4 μm thick)

Heat insulating layer: coating compound 28 (30 μm thick)

The third recording layer: coating compound 3 (4 μm thick)

Protective layer: UV curable resin (5 μm thick)

### Comparative Example 11

Supporting substrate: white polyethylene terephthalate (1 mm thick)

The first recording layer: coating compound 1 (4 μm thick)

Heat insulting layer: coating compound 28 (30 μm thick)

The second recording layer: coating compound 2 (4 μm thick)

Heat insulating layer: coating compound 28 (30 μm thick)

The third recording layer: coating compound 9 (4 μm thick)

Protective layer: UV curable resin (5 μm thick)

### Comparative Example 12

Supporting substrate: white polyethylene terephthalate (1 mm thick)

The first recording layer: coating compound 1 (4 μm thick)

Heat insulting layer: coating compound 28 (30 μm thick)

The second recording layer: coating compound 2 (4 μm thick)

Heat insulating layer: coating compound 28 (30 μm thick)

The third recording layer: coating compound 10 (4 μm thick)

Protective layer: UV curable resin (5 μm thick)

The samples of the reversible multicolor recording medium prepared in [Examples 1 to 6] and [Comparative Examples 1 to 14] mentioned above were tested for optical properties.

[Test Method for Optical Properties]

The reflection density (O.D.) of the ground of the entire recording medium was measured by using a Macbeth densitometer.

The absorbance of each recording layer constituting the recording medium was measured at the wavelength of the laser beam for recording by using a spectrophotometer, and absorption curves were drawn from the measured values.

The above-mentioned test was carried out by using a single recording layer which was formed on a transparent PET film for absorbance measurement in the same way as the recording medium.

Tables 1 to 5 below show the results of measurements in [Examples 1 to 6] and [Comparative Examples 1 to 14], and FIGS. 14 to 27 show the absorption curves drawn from the results of measurements. The measured values include the reflection density (O.D.) of the ground of the reversible multicolor recording medium as a whole and the absorbance of the single recording layer at the wavelength of the laser beam used for recording.

TABLE 1

| | Density of | Record- | Absorbance of | | | Absorp- |
|---|---|---|---|---|---|---|
| Recording | ground | ing | single recording layer | | | tion |
| medium | (O.D.) | layer | 800 nm | 860 nm | 930 nm | curve |
| Example 1 | 0.22 | First | 0.20 | 0.43 | 1.00 | |
| | | Second | 0.35 | 1.00 | 0.02 | |
| | | Third | 1.00 | 0.01 | 0.00 | |
| Example 2 | 0.22 | First | 0.20 | 0.43 | 1.00 | |
| | | Second | 0.35 | 1.00 | 0.02 | |
| | | Third | 1.00 | 0.01 | 0.00 | |
| | | Fourth | 0.00 | 0.00 | 0.00 | |
| Example 3 | 0.22 | First | 0.20 | 0.43 | 1.00 | |
| | | Second | 0.35 | 1.00 | 0.02 | |
| | | Third | 1.00 | 0.01 | 0.00 | |
| Example 4 | 0.22 | First | 0.20 | 0.43 | 1.00 | |
| | | Second | 0.35 | 1.00 | 0.02 | |
| | | Third | 1.00 | 0.01 | 0.00 | |
| Example 5 | 0.22 | First | 0.20 | 0.43 | 1.00 | |
| | | Second | 0.33 | 1.00 | 0.04 | |
| | | Third | 1.00 | 0.01 | 0.00 | |
| Example 6 | 0.24 | First | 0.20 | 0.43 | 1.00 | |
| | | Second | 0.58 | 1.00 | 0.02 | |
| | | Third | 1.00 | 0.01 | 0.00 | |
| Comparative | 0.22 | First | 0.20 | 0.43 | 1.00 | |
| Example 1 | | Second | 0.35 | 1.00 | 0.02 | |
| | | Third | 1.00 | 0.01 | 0.00 | |
| Comparative | 0.98 | First | 0.70 | 0.87 | 1.00 | |
| Example 2 | | Second | 0.89 | 1.00 | 0.76 | |
| | | Third | 1.00 | 0.44 | 0.09 | |

TABLE 2

| | Density of | Record- | Absorbance of | | | Absorp- |
|---|---|---|---|---|---|---|
| Recording | ground | ing | single recording layer | | | tion |
| medium | (O.D.) | layer | 785 nm | 860 nm | 980 nm | curve |
| Comparative | 0.67 | First | 0.23 | 0.49 | 1.00 | |
| Example 3 | | Second | 0.50 | 1.00 | 0.62 | |
| | | Third | 1.00 | 0.36 | 0.04 | |

TABLE 3

| | Density of | Record- | Absorbance of | | | Absorp- |
|---|---|---|---|---|---|---|
| Recording | ground | ing | single recording layer | | | tion |
| medium | (O.D.) | layer | 800 nm | 860 nm | 930 nm | curve |
| Comparative | 0.22 | First | 1.00 | 0.01 | 0.00 | |
| Example 4 | | Second | 0.35 | 1.00 | 0.02 | |
| | | Third | 0.20 | 0.43 | 1.00 | |
| Comparative | 1.02 | First | 0.18 | 0.46 | 1.00 | |
| Example 5 | | Second | 0.35 | 1.00 | 0.02 | |
| | | Third | 1.00 | 0.04 | 0.00 | |

TABLE 4

| | Density of | Record- | Absorbance of | | | Absorp- |
|---|---|---|---|---|---|---|
| Recording | ground | ing | single recording layer | | | tion |
| medium | (O.D.) | layer | 800 nm | 830 nm | 860 nm | curve |
| Comparative | 0.22 | First | 0.35 | 0.59 | 1.00 | |
| Example 6 | | Second | 0.58 | 1.00 | 0.42 | |
| | | Third | 1.00 | 0.26 | 0.01 | |

TABLE 2

| | Density of | Record- | Absorbance of | | | Absorp- |
|---|---|---|---|---|---|---|
| Recording | ground | ing | single recording layer | | | tion |
| medium | (O.D.) | layer | 800 nm | 860 nm | 930 nm | curve |
| Comparative | 0.23 | First | 0.20 | 0.43 | 1.00 | |
| Example 7 | | Second | 0.38 | 1.00 | 0.18 | |
| | | Third | 1.00 | 0.01 | 0.00 | |
| Comparative | 0.26 | First | 0.20 | 0.43 | 1.00 | |
| Example 8 | | Second | 1.01 | 1.00 | 0.02 | |
| | | Third | 1.00 | 0.01 | 0.00 | |
| Comparative | 0.26 | First | 0.20 | 0.43 | 1.00 | |
| Example 9 | | Second | 0.70 | 2.00 | 0.05 | |
| | | Third | 1.00 | 0.01 | 0.00 | |
| Comparative | 0.18 | First | 0.20 | 0.43 | 1.01 | |
| Example 10 | | Second | 0.18 | 0.50 | 0.01 | |
| | | Third | 1.00 | 0.01 | 0.00 | |
| Comparative | 0.26 | First | 0.20 | 0.43 | 1.01 | |
| Example 11 | | Second | 0.35 | 1.00 | 0.02 | |
| | | Third | 2.00 | 0.02 | 0.00 | |
| Comparative | 0.20 | First | 0.20 | 0.43 | 1.01 | |
| Example 12 | | Second | 0.35 | 1.00 | 0.02 | |
| | | Third | 0.50 | 0.00 | 0.00 | |

The samples of the reversible multicolor recording medium obtained in [Examples 1 to 6] and [Comparative Examples 1 to 14] mentioned above were tested for the recorded line width and the reflection density of solid images recorded by irradiation with semiconductor laser beams under various conditions.

[Test Method for Laser Recording]

Each sample was scanned with a semiconductor laser beam with any one wavelength selected from oscillation center wavelengths of 785 nm, 800 nm, 830 nm, 860 nm, and 930 nm. The laser beam has a spot shape of 30 μm by 200 μm and an output of 400 mW.

Scanning was performed by moving the laser beam in the direction parallel to the long axis of the spot shape of 200 μm at a rate of 3.5 m/s to measure the width of the recorded line.

Solid images were recorded by scanning a single laser beam (corresponding to each recording layer) with intervals of 20 μm at a rate of 3.5 m/s. The reflection density of the solid image was measured CMY (separately for Cyan, Magenta, and Yellow) by using a Macbeth densitometer.

Tables 6 to 10 below show the results of measurements (the width of lines recorded by a laser beam with an arbitrary wavelength and the change (ΔD) of reflection density for CMY in the samples of the reversible multicolor recording medium obtained in [Examples 1 to 6] and [Comparative Examples 1 to 14].

TABLE 6

| | | Width of line | | | | | |
|---|---|---|---|---|---|---|---|
| | | recorded by | | | | | |
| | | laser (μm) | | | | | |
| Recording | Recording | 800 | 860 | 930 | 800 nm | 860 nm | 930 nm |
| medium | layer | nm | nm | nm | ΔD (Y) | ΔD (M) | ΔD (C) |
| Example 1 | First | 0 | 0 | 17 | 1.17 | 1.34 | 1.33 |
| | Second | 0 | 18 | 0 | | | |
| | Third | 18 | 0 | 0 | | | |
| Example 2 | First | 0 | 0 | 17 | 1.15 | 1.35 | 1.33 |
| | Second | 0 | 18 | 0 | | | |
| | Third | 18 | 0 | 0 | | | |
| | Fourth | 0 | 0 | 0 | | | |
| Example 3 | First | 0 | 0 | 17 | 1.17 | 1.20 | 1.35 |
| | Second | 0 | 17 | 0 | | | |
| | Third | 18 | 0 | 0 | | | |
| Example 4 | First | 0 | 0 | 18 | 1.30 | 1.33 | 1.52 |
| | Second | 0 | 18 | 0 | | | |
| | Third | 19 | 0 | 0 | | | |
| Example 5 | First | 0 | 0 | 16 | 1.20 | 1.14 | 1.18 |
| | Second | 0 | 17 | 0 | | | |
| | Third | 18 | 0 | 0 | | | |
| Example 6 | First | 0 | 0 | 16 | 1.17 | 1.18 | 1.16 |
| | Second | 0 | 17 | 0 | | | |
| | Third | 18 | 0 | 0 | | | |
| Compar- | First | 0 | 0 | 15 | 0.93 | 0.93 | 1.00 |
| ative | Second | 0 | 15 | 0 | | | |
| Example 1 | Third | 16 | 0 | 0 | | | |
| Compar- | First | 0 | 0 | 0 | 1.30 | 0.09 | 0.08 |
| ative | Second | 0 | 2 | 15 | | | |
| Example 2 | Third | 19 | 10 | 0 | | | |

TABLE 7

| | | Width of line | | | | | |
|---|---|---|---|---|---|---|---|
| | | recorded by | | | | | |
| | | laser (μm) | | | | | |
| Recording | Recording | 785 | 860 | 980 | 785 nm | 860 nm | 980 nm |
| medium | layer | nm | nm | nm | ΔD (Y) | ΔD (M) | ΔD (C) |
| Compar- | First | 0 | 0 | 10 | 1.20 | 0.32 | 0.55 |
| ative | Second | 0 | 7 | 4 | | | |
| Example 3 | Third | 18 | 8 | 0 | | | |

TABLE 8

| | | Width of line | | | | | |
|---|---|---|---|---|---|---|---|
| | | recorded by | | | | | |
| | | laser (μm) | | | | | |
| Recording | Recording | 800 | 860 | 930 | 800 nm | 860 nm | 930 nm |
| medium | layer | nm | nm | nm | ΔD (Y) | ΔD (M) | ΔD (C) |
| Compar- | First | 0 | 0 | 0 | 0.11 | 0.08 | 0.05 |
| ative | Second | 10 | 2 | 0 | | | |
| Example 4 | Third | 3 | 12 | 18 | | | |
| Compar- | First | 0 | 0 | 16 | 1.19 | 1.17 | 1.16 |
| ative | Second | 0 | 17 | 0 | | | |
| Example 5 | Third | 18 | 0 | 0 | | | |

TABLE 9

| | | Width of line | | | | | |
|---|---|---|---|---|---|---|---|
| | | recorded by | | | | | |
| | | laser (μm) | | | | | |
| Recording | Recording | 800 | 830 | 860 | 800 nm | 830 nm | 860 nm |
| medium | layer | nm | nm | nm | ΔD (Y) | ΔD (M) | ΔD (C) |
| Compar- | First | 0 | 0 | 3 | 1.15 | 0.38 | 0.13 |
| ative | Second | 0 | 8 | 13 | | | |
| Example 6 | Third | 18 | 6 | 0 | | | |

TABLE 10

| | | Width of line | | | | | |
|---|---|---|---|---|---|---|---|
| | | recorded by | | | | | |
| | Record- | laser (μm) | | | | | |
| Recording | ing | 800 | 860 | 930 | 800 nm | 860 nm | 930 nm |
| medium | layer | nm | nm | nm | ΔD (Y) | ΔD (M) | ΔD (C) |
| Comparative | First | 0 | 0 | 9 | 1.17 | 1.20 | 0.47 |
| Example 7 | Second | 0 | 17 | 2 | | | |
| | Third | 18 | 0 | 0 | | | |
| Comparative | First | 0 | 0 | 16 | 1.19 | 1.18 | 1.16 |
| Example 8 | Second | 0 | 17 | 0 | | | |
| | Third | 18 | 0 | 0 | | | |
| Comparative | First | 0 | 0 | 16 | 1.18 | 1.15 | 1.18 |
| Example 9 | Second | 0 | 17 | 0 | | | |
| | Third | 18 | 0 | 0 | | | |
| Comparative | First | 0 | 2 | 16 | 1.18 | 0.65 | 1.17 |
| Example 10 | Second | 0 | 12 | 0 | | | |
| | Third | 18 | 0 | 0 | | | |
| Comparative | First | 0 | 0 | 16 | 1.19 | 1.16 | 1.16 |
| Example 11 | Second | 0 | 17 | 0 | | | |
| | Third | 18 | 0 | 0 | | | |
| Comparative | First | 0 | 0 | 17 | 0.54 | 1.18 | 1.30 |
| Example 12 | Second | 2 | 17 | 0 | | | |
| | Third | 12 | 0 | 0 | | | |

[Results of Evaluation]

The recording medium in Example 1 produced good colors of yellow, magenta, and cyan without color fogging when recording was made with laser beams each having the oscillation center wavelength of 800, 860, and 930 nm, as indicated by the absorption characteristics in FIG. 14. Upon irradiation with more than one laser beam, it also produced an intermediate color corresponding to them.

Any change in the output of laser beam caused the developed color to vary in color tone.

The recording medium became clear of all the images made by laser beams when it was kept in contact with a hot stamp at 120° C. for one second. In addition, it was capable of repeated recording when irradiated with laser beams.

The recording medium in Example 2 also produced good colors of yellow, magenta, and cyan without color fogging when recording was made with laser beams each having the oscillation center wavelength of 800, 860, and 930 nm, as indicated by the absorption characteristics in FIG. 14. Upon irradiation with more than one laser beam, it also produced an intermediate color corresponding to them.

Any change in the output of laser beam caused the developed color to vary in color tone.

The recording medium produced black images in recording with a heat-sensitive printer provided with a thermal head.

The recording medium became clear of all the images made by laser beams when it was kept in contact with a hot stamp at 120° C. for one second. In addition, it was capable of repeated recording when irradiated with laser beams.

The recording medium in Example 3 also produced good colors of yellow, magenta, and cyan without color fogging when recording was made with laser beams each having the oscillation center wavelength of 800, 860, and 930 nm, as indicated by the absorption characteristics in FIG. 14. Upon irradiation with more than one laser beam, it also produced an intermediate color corresponding to them.

Any change in the output of laser beam caused the developed color to vary in color tone.

The recording medium became clear of all the images made by laser beams when it was kept in contact with a hot stamp at 120° C. for one second. In addition, it was capable of repeated recording when irradiated with laser beams.

The recording medium in Example 4 also produced good colors of yellow, magenta, and cyan without color fogging when recording was made with laser beams each having the oscillation center wavelength of 800, 860, and 930 nm, as indicated by the absorption characteristics in FIG. 14.

Upon irradiation with more than one laser beam, it also produced an intermediate color corresponding to them.

Any change in the output of laser beam caused the developed color to vary in color tone.

The recording medium became clear of all the images made by laser beams when it was kept in contact with a hot stamp at 120° C. for one second. In addition, it was capable of repeated recording when irradiated with laser beams.

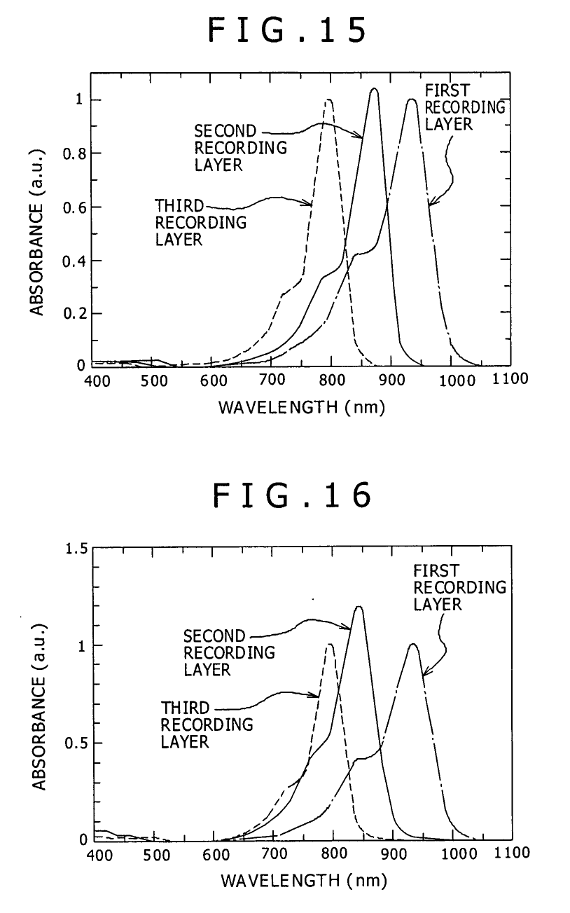

The recording medium in Example 5 produced good colors of yellow, magenta, and cyan without color fogging when recording was made with laser beams each having the oscillation center wavelength of 800, 860, and 930 nm, as indicated by the absorption characteristics in FIG. 15. Upon irradiation with more than one laser beam, it also produced an intermediate color corresponding to them.

Any change in the output of laser beam caused the developed color to vary in color tone.

The recording medium became clear of all the images made by laser beams when it was kept in contact with a hot stamp at 120° C. for one second. In addition, it was capable of repeated recording when irradiated with laser beams.

The recording medium in Example 6 produced good colors of yellow, magenta, and cyan without color fogging when recording was made with laser beams each having the oscillation center wavelength of 800, 860, and 930 nm, as indicated by the absorption characteristics in FIG. 16. Upon irradiation with more than one laser beam, it also produced an intermediate color corresponding to them.

Any change in the output of laser beam caused the developed color to vary in color tone.

The recording medium became clear of all the images made by laser beams when it was kept in contact with a hot stamp at 120° C. for one second. In addition, it was capable of repeated recording when irradiated with laser beams.

The recording medium in Comparative Example 1 produced images of yellow, magenta, and cyan when recording was made with laser beams each having the oscillation center wavelength of 800, 860, and 930 nm; however, the color development of the images are weaker than those in Example 4.

This result suggests that the layer containing the light-heat converting composition should be formed at a position close to the supporting substrate side (or a position away from the top surface into which the laser beam for recording enters) in the case of a recording layer of laminate structure which contains separately the light-heat converting composition and the reversible thermal developing composition.

The recording medium in Comparative Example 2 produced images when recording was made with laser beams each having the oscillation center wavelength of 800, 860, and 930 nm, as indicated by the absorption characteristics in FIG. 17. However, it was much poorer in visibility than that in Example 4 on account of a high density of its ground.

In addition, recording with the second recording layer alone or the first recording layer alone was impossible because of color fogging.

This result suggests that the light-heat converting composition should be formed by coating from a solution in a binder rather than being in the form of its crystalline thin film in the case where the light-heat converting composition and the reversible thermal developing composition exist separately and independently in the recording layer.

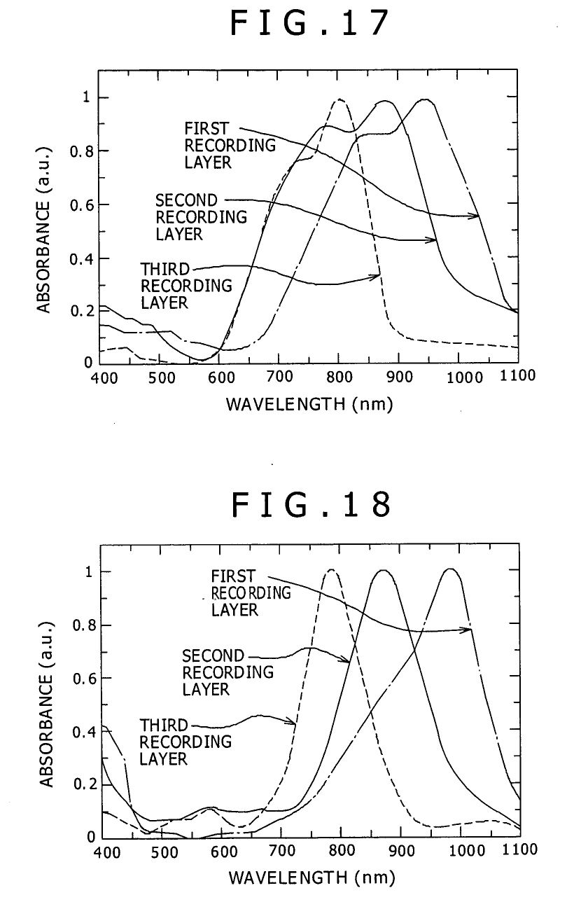

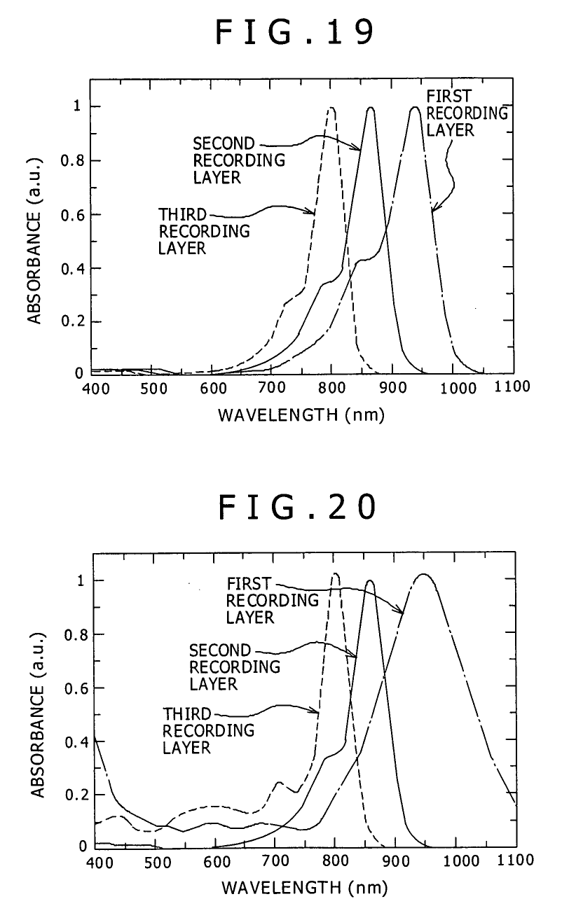

The recording medium in Comparative Example 3 produced images when recording was made with laser beams each having the oscillation center wavelength of 785, 860, and 980 nm, as indicated by the absorption characteristics in FIG. 18. However, it was much poorer in visibility than that in Example 1 on account of a high density of its ground.

In addition, recording with the second recording layer alone or the first recording layer alone was impossible because of color fogging.

This result suggests that the light-heat converting composition should be the one having a narrow absorber, such as phthalocyanine dye, naphthalocyanine dye, cyanine dye, squarilium dye, croconium dye, and other polymethylene dyes, rather than iminium salt dye or nickel complex dye.

The recording medium in Comparative Example 4 produced images when recording was made with laser beams each having the oscillation center wavelength of 785, 860, and 980 nm, as indicated by the absorption characteristics in FIG. 19. However, recording with the second recording layer alone or the first recording layer alone was impossible on account of color fogging.

This result suggests that it is desirable that the recording layers should be sequentially arranged upward (from the supporting substrate side) according as the absorption wavelength of the light-heat converting composition decreases.

The recording medium in Comparative Example 5 produced images when recording was made with laser beams each having the oscillation center wavelength of 800, 860, and 930 nm, as indicated by the absorption characteristics in FIG. 20. However, it was much poorer in visibility than that in Example 1 on account of a high density of its ground.

This result suggests that each recording layer should have a reflection density no higher than 0.6 at its development wavelength when the recording medium is quenched.

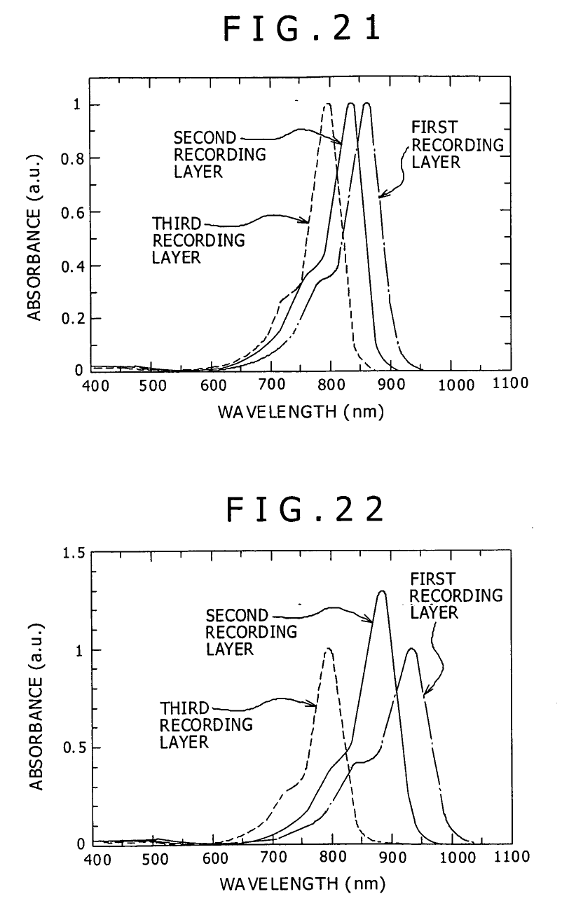

The recording medium in Comparative Example 6 produced images when recording was made with laser beams each having the oscillation center wavelength of 800, 830, and 860 nm, as indicated by the absorption characteristics in FIG. 21. However, recording with the second recording layer alone or the first recording layer alone was impossible on account of color fogging.

This result suggests that the oscillation center wavelengths of the laser beams for recording should be no less than 40 nm apart from each other.

The recording medium in Comparative Example 7 produced images when recording was made with laser beams each having the oscillation center wavelength of 800, 860, and 930 nm, as indicated by the absorption characteristics in FIG. 22. However, recording with the second recording layer alone or the first recording layer alone was impossible on account of color fogging which resulted from a large difference between the oscillation center wavelength λ_{N} of the laser beam for recording and the absorption peak wavelength λ max N of the light-heat converting composition in the corresponding recording layer.

This result suggests that the oscillation center wavelength λ_{N} of the laser beam for recording and the absorption peak wavelength λ max N of the light-heat converting composition in the corresponding recording layer should satisfy the relation (λ max N−15 nm<λ_{N}<(λ max N+20 nm)

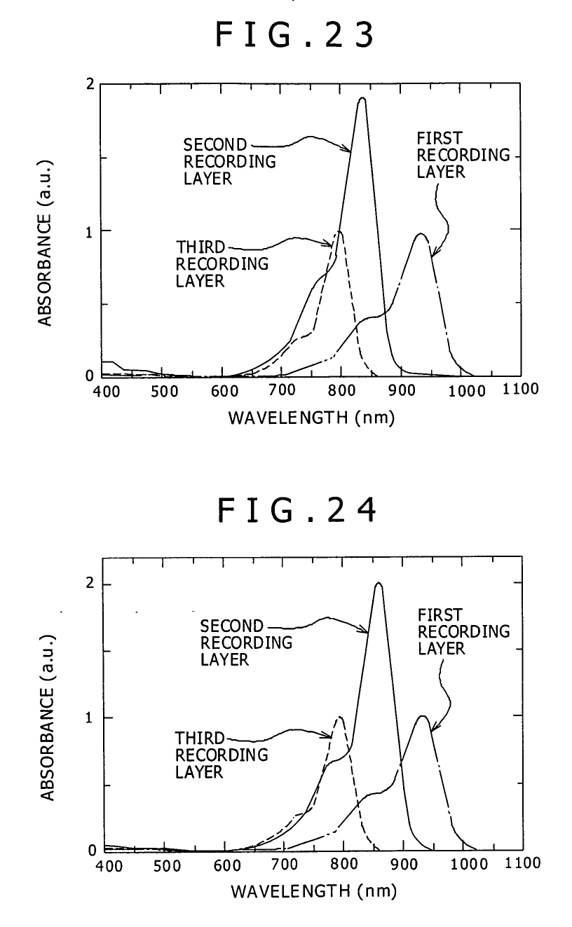

The recording medium in Comparative Example 8 produced images when recording was made with laser beams each having the oscillation center wavelength of 800, 860, and 930 nm, as indicated by the absorption characteristics in FIG. 23.

The resulting images of yellow, magenta, and cyan were good in color development without color fogging, although the second recording layer does not satisfy the relation (λ max N−15 nm)<λ_{N}<(λ max N+20 nm).

Nevertheless, it has nearly the same recording sensitivity (in terms of the width of recorded lines and the reflection density of images) as the recording media in Examples 1, 5, and 6, although it contains about twice as much light-heat converting composition (dye) as them. The dye added in an excessively large amount posed problems with cost, ground density, and solubility.

When the practical recording sensitivity is considered from the view point of cost, ground density, and material solubility, it is apparent that the oscillation center wavelength λ_{N} of the laser beam for recording and the absorption peak wavelength λ max N of the light-heat converting composition in the corresponding recording layer should satisfy the relation (λ max N−15 nm)<λ_{N}<(λ max N+20 nm).

The recording medium in Comparative Example 9 produced good images of yellow, magenta, and cyan without color fogging when recording was made with laser beams each having the oscillation center wavelength of 800, 860, and 930 nm, as indicated by the absorption characteristics in FIG. 24.

The recording medium in this comparative example differs from that in Example 1 in that the second recording layer contains about twice as much light-heat converting composition (dye) so that its absorbance is increased more than 1.5 times. Nevertheless, it has nearly the same recording sensitivity (in terms of the width of recorded lines and the reflection density of images) as the recording medium in Example 1 and it is poor in visibility owing to its high ground density.

When the practical recording sensitivity is considered from the view point of cost, ground density, and material solubility, it is apparent that the oscillation center wavelength λ_{N} of the laser beam for recording and the absorbance Abs.N(λ_{N}) of the light-heat converting composition in the corresponding recording layer should satisfy the relation 1.5>Abs.N(λ_{N}).

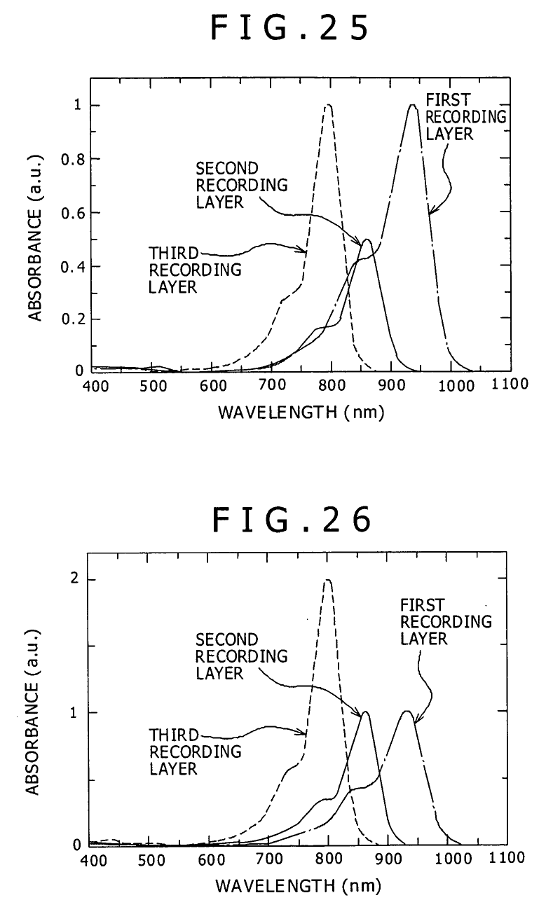

The recording medium in Comparative Example 10 produced images when recording was made with laser beams each having the oscillation center wavelength of 800, 860, and 930 nm, as indicated by the absorption characteristics in FIG. 25. This recording medium was inferior to that in Example 1 in that the second recording layer has a lower recording sensitivity.

Also, recording with the second recording layer alone was impossible on account of color fogging.

This result suggests that the oscillation center wavelength λ_{N} of the laser beam for recording and the absorbance Abs.N(λ_{N}) of the light-heat converting composition in the corresponding recording layer should satisfy the relation Abs.N(λ_{N})>0.6.

The recording medium in Comparative Example 11 produced good images of yellow, magenta, and cyan without color fogging when recording was made with laser beams each having the oscillation center wavelength of 800, 860, and 930 nm, as indicated by the absorption characteristics in FIG. 26.

The recording medium in this comparative example differs from that in Example 1 in that the third recording layer contains about twice as much light-heat converting composition (dye) so that its absorbance is increased more than 1.5 times. Nevertheless, it has nearly the same recording sensitivity (in terms of the width of recorded lines and the reflection density of images) as the recording medium in Example 1 and it is poor in visibility owing to its high ground density.

When the practical recording sensitivity is considered from the view point of cost, ground density, and material solubility, it is apparent that the oscillation center wavelength λ_{N} of the laser beam for recording and the absorbance Abs.N(λ_{N}) of the light-heat converting composition in the corresponding recording layer should satisfy the relation 1.5>Abs.N(λ_{N}).

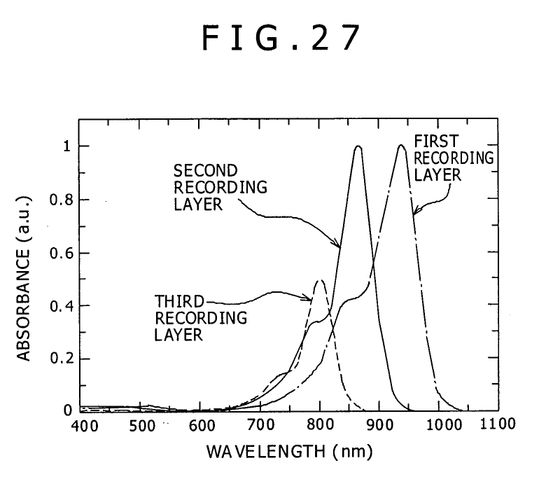

The recording medium in Comparative Example 12 gave the absorption characteristics as shown in FIG. 27.

It differs from that in Comparative Example 1 in that the third recording layer has an absorbance less than 0.6. However, when recording was made with laser beams each having the oscillation center wavelength of 800, 860, and 930 nm, the third recording layer was poorer than that in the recording medium of Example 1.

In addition, recording with the third recording layer alone was impossible on account of color fogging.

This result suggests that the relation Abs.N(λ_{N})>0.6 should be satisfied between the oscillation wavelength λ_{N} of the laser beam for recording and the absorbance Abs.N(λ_{N}) of the light-heat converting composition in the corresponding recording layer.

### INDUSTRIAL APPLICABILITY

The present invention covers a recording medium which reversibly takes on the color developed state and the color quenched state and hence which records clear images free of color fogging and erases images when the recording layers therein (numbered from the first to the nth) are irradiated with near infrared laser beams having specific absorption peak wavelengths of λ max 1, λ max 2, . . . , λ max n in the near infrared region such that λ max 1 >λ max 2> . . . >λ max n, so that the desired recording layer is selectively heated.

1-22. (canceled)

23. A reversible multicolor recording medium comprising a plurality of recording layers numbered from a first to a nth layer, which are formed on a supporting substrate side separately and independently in sequential order, said recording layers each containing a reversible thermal color developing composition differing from one another in hue of a developed color and further containing a light-heat converting composition which generates heat upon absorption of near infrared rays with a wavelength in different ranges, and said recording layers having respectively absorption peak wavelengths λ max 1, λ max 2, . . . , λ max n, in a near infrared region such that 1500 nm>λ max 1>λ max 2> . . . >λ max n>750 nm.

24. The reversible multicolor recording medium as defined in claim 23, wherein the reversible thermal color developing composition contains an electron-donating color developing compound and an electron-accepting developing-quenching agent and the recording layers reversibly take on a color-developed state and a color-quenched state due to a reversible reaction between the electron-donating color developing compound and the electron-accepting developing-quenching agent.

25. The reversible multicolor recording medium as defined in claim 23, wherein the recording layer in quenched state thereof has a reflection density no higher than 0.6 at a developing peak wavelength.

26. The reversible multicolor recording medium as defined in claim 24, wherein the nth recording layer that is positioned upward from the supporting substrate and that contains the light-heat converting composition has an absorbance of Abs.N(λ) which satisfies a relation as follows:
1.5>Abs.N(λ_{N})>0.6
Abs.1(λ₁)>0.6
Abs.N(λ_{N-1}), . . . , Abs.N(λ₂), Abs.N(λ₁)<0.2,
where N=2, 3, . . . , n.

27. The reversible multicolor recording medium as defined in claim 23, wherein the following relation is satisfied between the absorption peak wavelength (λ max 1, λ max 2, . . . , λ max n) in near infrared region of the first to nth recording layers and an oscillation center wavelengths (λ₁, 1, . . . , λₙ) associated with laser beams to be directed to each recording layer:
(λ max N−15 nm)<λ_{N}<(λ max N+20 nm),
where N=2, . . . , n.

28. The reversible multicolor recording medium as defined in claim 23, wherein the recording layer contains the light-heat converting composition and the reversible thermal color developing composition in a mixed state.

29. The reversible multicolor recording medium as defined in claim 23, wherein the recording layer contains the light-heat converting composition and the reversible thermal color developing composition in a mutually separated state.

30. The reversible multicolor recording medium as defined in claim 24, wherein the light-heat converting composition is separated by a resin binder.

31. The reversible multicolor recording medium as defined in claim 23, wherein the top of the first to nth recording layers is covered with an upper recording layer which contains a reversible thermal color developing composition differing in hue from the first to nth recording layers and the upper recording layer does not contain the light-heat converting composition.

32. The reversible multicolor recording medium as defined in claim 23, wherein the first to nth recording layers are formed in sequence on top of each other, with a heating insulating layer interposed between adjacent layers.

33. The reversible multicolor recording medium as defined in claim 23, wherein the recording layers include two to four layers.

34. The reversible multicolor recording medium as defined in claim 33, wherein the recording layers include four layers and each of the recording layers has a hue selected from yellow, cyan, magenta, and black.

35. The reversible multicolor recording medium as defined in claim 33, wherein the recording layers include three layers and each of the recording layers has a hue selected from yellow, cyan, and magenta.

36. The reversible multicolor recording medium as defined in claim 23, wherein a protective layer is formed on an uppermost surface of the recording layers.

37. The reversible multicolor recording medium as defined in claim 23, wherein the light-heat converting composition contained in the second to nth recording layers, excluding the first recording layer adjacent to the supporting substrate, contains an organic dye.

38. The reversible multicolor recording medium as defined in claim 37, wherein the organic dye is at least one species of a polymethine dye selected from the group consisting of phthalocyanine dye, naphthalocyanien dye, cyanine dye, squarilium dye, and croconium dye.

39. A method for recording on a reversible multicolor recording medium, the method comprising irradiation with arbitrary selected laser beams having oscillation center wavelengths (λ₁, λ₂, . . . , λₙ) that range from 750 nm to 1500 nm, wherein said reversible multicolor recording medium has recording layers numbered from a first to a nth, which are formed on a supporting substrate side separately and independently in sequential order, wherein said recording layers each contain a reversible thermal color developing composition differing from one another in hue associated with a developed color and further containing a light-heat converting composition which generates heat upon absorption of near infrared rays with a wavelength in different ranges, and wherein said recording layers having respectively an absorption peak wavelengths λ max 1, λ max 2, . . . , λ max n, in an near infrared region such that 1500 nm>λ max 1>λ max 2> . . . >λ max n>750 nm.

40. The method for recording on a reversible multicolor recording medium as defined in claim 39, wherein the laser beams are generated from a semiconductor laser source.

41. The method for recording on a reversible multicolor recording medium as defined in claim 39, wherein the laser beams each have the oscillation center wavelengths (λ₁, λ₂, . . . , λₙ), which are separate from each other by more than 40 nm.

42. The method for recording on a reversible multicolor recording medium as defined in claim 39, wherein a total number of the laser beams differing in the oscillation center wavelength is equal to a total number of the light-heat converting compositions which are contained in the first to nth recording layers so as to generate heat upon absorption of light in the mutually different regions of wavelength.

43. The method for recording on a reversible multicolor recording medium as defined in claim 39, wherein the nth recording layer that is numbered upward from the supporting substrate and that contains the light-heat converting composition has an absorbance of Abs.N(λ) and the laser beams for recording have the oscillation center wavelength (λ₁, λ₂, . . . , λₙ) such that a relation is satisfied as follows:
1.5>Abs.N(λ_{N})>0.6
Abs.1(λ₁)>0.6
Abs.N(λ_{N-1}), . . . , Abs.N(λ₂), Abs.N(λ₁)<0.2,
where N=2, 3, . . . , n.

44. The method for recording on a reversible multicolor recording medium as defined in claim 39, wherein a relation is satisfied between the absorption peak wavelength (λ max 1, λ max 2, . . . , λ max n) in near infrared region of the first to nth recording layers and the oscillation center wavelengths (λ₁, λ₂, . . . , λₙ) of the laser beams as follows:
(λ max N−15 nm)<λ_{N}<(λ max N+20 nm),
where N=2, . . . , n.
